(19) United States
(12) Patent Application Publication
(10) Pub. No.: US 2017/0345412 A1
(43) Pub. Date: Nov. 30, 2017

(54) SPEECH PROCESSING DEVICE, SPEECH PROCESSING METHOD, AND RECORDING MEDIUM

(71) Applicant: NEC Corporation, Minato-ku, Tokyo (JP)

(72) Inventors: Yasuyuki MITSUI, Tokyo (JP); Reishi KONDO, Tokyo (JP)

(73) Assignee: NEC Corporation, Minato-ku, Tokyo (JP)

(21) Appl. No.: 15/536,212

(22) PCT Filed: Dec. 17, 2015
(86) PCT No.: PCT/JP2015/006283

§ 371 Date: Jun. 15, 2017

(30) Foreign Application Priority Data
Dec. 24, 2014 (JP) 2014-260168

(51) Int. Cl. G10L 13/10; G10L 13/07; G10L 13/027

(52) U.S. Cl. CPC G10L 13/10; G10L 13/027; G10L 13/07

(57) ABSTRACT

A speech processing device according to an aspect of the present invention examines precision and quality of each piece of data stored in a database so that it is able to generate highly stable synthesized speech close to human voice

A speech processing device according to an aspect of the present invention includes a first storing means for storing an original-speech F0 pattern being an F0 pattern extracted from recorded speech and first determination information associated with the original-speech F0 pattern, and a first determining means for determining whether or not to reproduce an original-speech F0 pattern, in accordance with first determination information.

### TECHNICAL FIELD

The present invention relates to a technology of processing speech.

### BACKGROUND ART

A speech synthesis technology of converting text into speech and outputting the speech has been recently known.

PTL 1 discloses a technology of checking text data to be synthesized against an original speech content of data stored in an element waveform database to generate synthesized speech. In a segment in which stored data match an utterance content, a speech synthesis device described in PTL 1 concatenates element waveforms extracted from utterance data of a relevant original-speech, minimizing editing of an F0 pattern being time variation of a fundamental frequency of the original-speech (hereinafter referred to as original speech F0). In a segment in which stored data do not match an utterance content, the speech synthesis device generates synthesized speech by using an element waveform selected by using a standard F0 pattern and a common unit selection technique. PTL 3 discloses the same technology.

PTL 2 discloses a technology of generating synthesized speech from a human utterance and text information. A prosody generation device described in PTL 2 extracts a speech prosodic pattern from a human utterance and extracts a high-reliability pitch pattern from the speech prosodic pattern. The prosody generation device generates a regular prosodic pattern from text and modifies the regular prosodic pattern to be approximated to the high-reliability pitch pattern. The prosody generation device generates a corrected prosodic pattern by concatenating the high-reliability pitch pattern with the modified regular prosodic pattern. The prosody generation device generates synthesized speech by using the corrected prosodic pattern.

PTL 4 describes a speech synthesis system evaluating consistency of prosody by applying a statistical model of variation of prosody to both paths of phoneme selection and correction amount search. The speech synthesis system searches for a sequence of prosody-correction-amount for minimizing a corrected prosody cost.

### CITATION LIST

### Patent Literature

[PTL 1] Japanese Patent No. 5387410
[PTL 2] Japanese Unexamined Patent Application Publication No. 2008-292587
[PTL 3] International Application Publication No. WO 2009/044596
[PTL 4] Japanese Unexamined Patent Application Publication No. 2009-063869

### SUMMARY OF INVENTION

### Technical Problem

However, the technologies in PTLs 1, 3, and 4 do not examine precision and quality of each piece of data stored in a database. For example, an amount of recorded speech data for creating a speech synthesis database becomes enormous, and therefore, normally, data related to F0 are automatically extracted and created by a computer controlled by a program. Accordingly, it is difficult to perform automatic extraction of F0 with perfect precision. Specifically, there is a potential problem of extraction of F0 corresponding to a double pitch or a half pitch, omitted extraction of F0 in a voiced segment, misinsertion of F0 in an unvoiced segment, and the like. Consequently, incorrect F0 may be extracted. Further, unclear speech caused by noise in recording, idleness of utterance, and the like may be mixed into an element waveform. That is to say, for example, the technology in PTL 1 has a problem that, when reproducing an F0 pattern and a waveform by using data including incorrect F0 and an element waveform of an unclear utterance, quality of the reproduced speech is significantly degraded.

Further, the technology in PTL 2 does not store F0 pattern data of original speech in a database, and therefore requires an utterance for extracting a prosodic pattern each time for synthesizing speech. Additionally, there is no mention of quality of an element waveform.

An object of the present invention is to provide a technology that is able to generate highly stable synthesized speech close to human voice, in view of the aforementioned problem.

### Solution to Problem

A speech processing device according to an aspect of the present invention includes a first storing means for storing an original-speech F0 pattern being an F0 pattern extracted from recorded speech and first determination information associated with the original-speech F0 pattern, and a first determining means for determining whether or not to reproduce an original-speech F0 pattern, in accordance with first determination information.

A speech processing method according to an aspect of the present invention stores an original-speech F0 pattern being an F0 pattern extracted from recorded speech and first determination information associated with the original-speech F0 pattern, and determines whether or not to reproduce an original-speech F0 pattern, in accordance with first determination information.

A recording medium according to an aspect of the present invention stores a program causing a computer to perform processing of storing an original-speech F0 pattern being an F0 pattern extracted from recorded speech and first determination information associated with the original-speech F0 pattern, and processing of determining whether or not to reproduce an original-speech F0 pattern, in accordance with first determination information. The present invention is also implemented by a program stored in the aforementioned recording medium.

### Advantageous Effects of Invention

The present invention generates highly stable synthesized speech close to human voice, and therefore provides an effect that a suitable F0 pattern can be reproduced.

### BRIEF DESCRIPTION OF DRAWINGS

FIG. 1 is a block diagram illustrating a configuration example of a speech processing device according to a first example embodiment of the present invention.

FIG. 2 is a flowchart illustrating an operation example of the speech processing device according to the first example embodiment of the present invention.

FIG. 3 is a block diagram illustrating a configuration example of a speech processing device according to a second example embodiment of the present invention.

FIG. 4 is a flowchart illustrating an operation example of the speech processing device according to the second example embodiment of the present invention.

FIG. 5 is a block diagram illustrating a configuration example of a speech processing device according to a third example embodiment of the present invention.

FIG. 6 is a flowchart illustrating an operation example of the speech processing device according to the third example embodiment of the present invention.

FIG. 7 is a block diagram illustrating a configuration example of a speech processing device according to a fourth example embodiment of the present invention.

FIG. 8 is a flowchart illustrating an operation example of the speech processing device according to the fourth example embodiment of the present invention.

FIG. 9 is a diagram illustrating an example of an original-speech applicable segment according to the fourth example embodiment of the present invention.

FIG. 10 is a diagram illustrating an example of attribute information of a standard F0 pattern according to the fourth example embodiment of the present invention.

FIG. 11 is a diagram illustrating an example of an original-speech F0 pattern according to the fourth example embodiment of the present invention.

FIG. 12 is a block diagram illustrating a configuration example of a speech processing device according to a fifth example embodiment of the present invention.

FIG. 13 is a block diagram illustrating a hardware configuration example of a computer capable of providing the speech processing device according to the example embodiments of the present invention.

FIG. 14 is a block diagram illustrating a configuration example of the speech processing device according to the first example embodiment of the present invention, being implemented with dedicated circuits.

FIG. 15 is a block diagram illustrating a configuration example of the speech processing device according to the second example embodiment of the present invention, being implemented with dedicated circuits.

FIG. 16 is a block diagram illustrating a configuration example of the speech processing device according to the third example embodiment of the present invention, being implemented with dedicated circuits.

FIG. 17 is a block diagram illustrating a configuration example of the speech processing device according to the fourth example embodiment of the present invention, being implemented with dedicated circuits.

FIG. 18 is a block diagram illustrating a configuration example of the speech processing device according to the fifth example embodiment of the present invention, being implemented with dedicated circuits.

### DESCRIPTION OF EMBODIMENTS

First, in order to facilitate understanding of example embodiments of the present invention, a speech synthesis technology will be described.

For example, processing in a speech synthesis technology includes language analysis processing, prosodic information generation processing, and waveform generation processing. The language analysis processing generates utterance information including, for example, read information, by linguistically analyzing input text by using a dictionary and the like. The prosodic information generation processing generates prosodic information such as phoneme duration and an F0 pattern by using, for example, a rule and a statistical model, in accordance with the aforementioned utterance information. The waveform generation processing generates a speech waveform by using, for example, an element waveform being a short-time waveform and a modeled feature value vector, in accordance with utterance information and prosodic information.

Next, referring to the drawings, example embodiments of the present invention will be described below. For each example embodiment, a similar component is given a same reference sign, and description thereof is omitted as appropriate. Each example embodiment described below is an exemplification, and the present invention is not limited to a content of each example embodiment below.

### First Example Embodiment

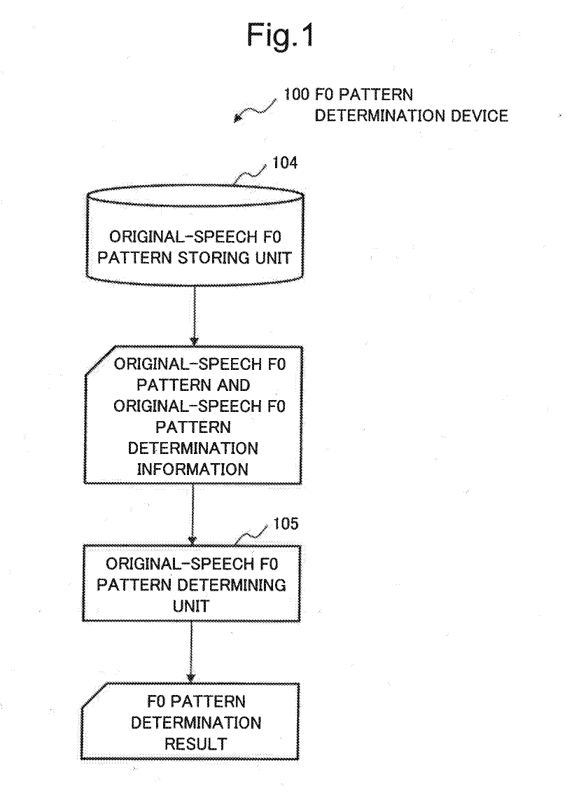

Referring to drawings, an F0 determination device 100 being a speech processing device according to a first example embodiment will be described in detail below. FIG. 1 is a block diagram illustrating a processing configuration example of the F0 pattern determination device 100 according to the first example embodiment of the present invention. Referring to FIG. 1, the F0 pattern determination device 100 according to the present example embodiment includes an original-speech F0 pattern storing unit 104 (first storing unit) and an original-speech F0 pattern determining unit 105 (first determining unit). Note that reference signs given in FIG. 1 are given to respective components for convenience as an example for facilitating understanding, and are not intended to limit the present invention in any way.

Further, a direction of data transmission in FIG. 1 and other block diagrams illustrating configurations of speech processing devices according to other example embodiments of the present invention is not limited to a direction of an arrow.

The original-speech F0 pattern storing unit 104 stores a plurality of original-speech F0 patterns. Each original-speech F0 pattern is given with original-speech F0 pattern determination information. The original-speech F0 pattern storing unit 104 may store the plurality of original-speech F0 patterns and the original-speech F0 pattern determination information associated with each of the original-speech F0 patterns.

The original-speech F0 pattern determining unit 105 determines whether or not to apply an original-speech F0 pattern, in accordance with original-speech F0 pattern determination information stored in the original-speech F0 pattern storing unit 104.

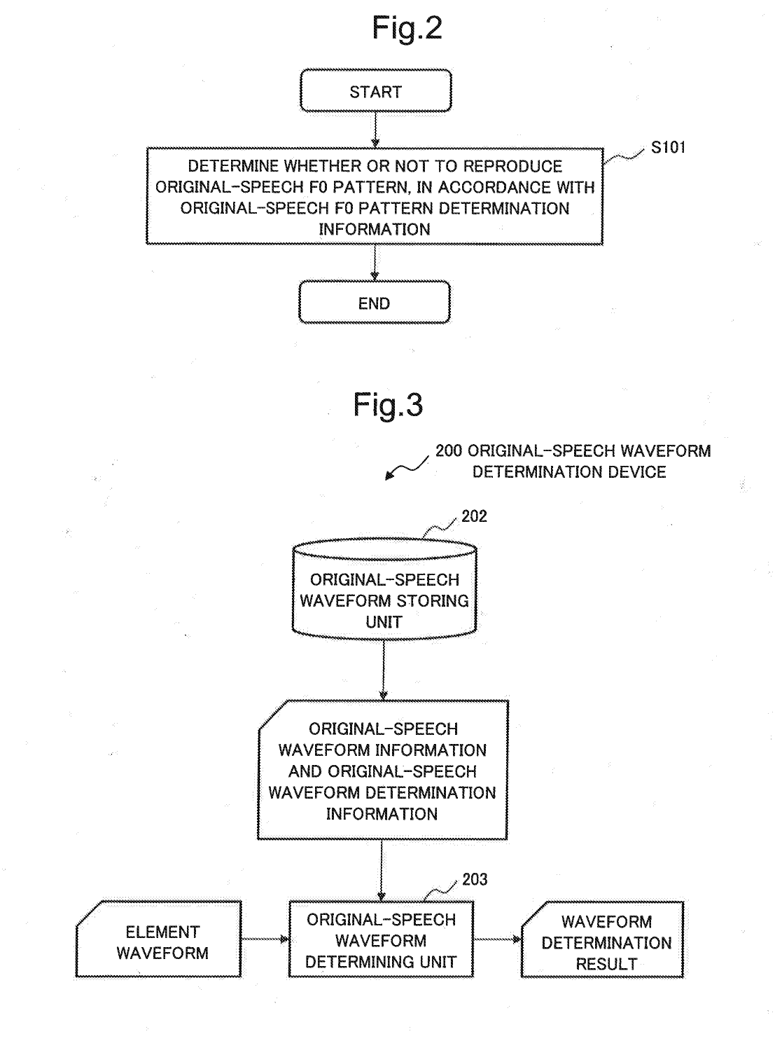

Using FIG. 2, an operation of the present example embodiment will be described. FIG. 2 is a flowchart illustrating an operation example of the F0 pattern determination device 100 according to the first example embodiment of the present invention.

The original-speech F0 pattern determining unit 105 determines whether or not to apply an original-speech F0 pattern related to an F0 pattern of speech data, in accordance with the original-speech F0 pattern determination information stored in the original-speech F0 pattern storing unit 104 (Step S101). In other words, the original-speech F0 pattern determining unit 105 determines whether or not to use an original-speech F0 pattern as an F0 pattern of speech data to be synthesized in speech synthesis, in accordance with the original-speech F0 pattern determination information given to the original-speech F0 pattern.

As described above, the present example embodiment determines applicability in accordance with predetermined original-speech F0 pattern determination information, and therefore is able to prevent reproduction of an original-speech F0 pattern that causes degradation of naturalness of prosody. In other words, speech synthesis can be performed without using an original-speech F0 pattern that degrades naturalness of prosody, out of original-speech F0 patterns. That is to say, the present example embodiment generates highly stable synthesized speech close to human voice, and therefore is able to reproduce a suitable F0 pattern.

Further, a speech synthesis device using the F0 determination device 100 according to the present example embodiment is able to reproduce a suitable F0 pattern, and therefore is able to generate highly stable synthesized speech close to human voice.

### Second Example Embodiment

A second example embodiment of the present invention will be described. FIG. 3 is a block diagram illustrating a processing configuration example of an original-speech waveform determination device 200 being a speech processing device according to the second example embodiment of the present invention. Referring to FIG. 3, the original-speech waveform determination device 200 according to the present example embodiment includes an original-speech waveform storing unit 202 and an original-speech waveform determining unit 203.

The original-speech waveform storing unit 202 stores original-speech waveform information extracted from recorded speech. Each piece of original-speech waveform information is given with original-speech waveform determination information. The original-speech waveform information refers to information capable of nearly faithfully reproducing a recorded speech waveform being an extraction source. For example, the original-speech waveform information is a short-time unit element waveform extracted from a recorded speech waveform or spectral information generated by a fast Fourier transform (FFT). Further, for example, the original-speech waveform information may be information generated by speech coding such as pulse code modulation (PCM) or adaptive transform coding (ATC), or information generated by an analysis-synthesis system such as a vocoder.

The original-speech waveform determining unit 203 determines whether or not to reproduce an original recorded speech waveform by using original-speech waveform information, in accordance with original-speech waveform determination information accompanying (i.e. given to) the original-speech waveform information stored in the original-speech waveform storing unit 202 (Step S201). In other words, the original-speech waveform determining unit 203 determines whether or not to use original-speech waveform information for reproduction of a speech waveform (i.e. speech synthesis), in accordance with original-speech waveform determination information given to the original-speech waveform information.

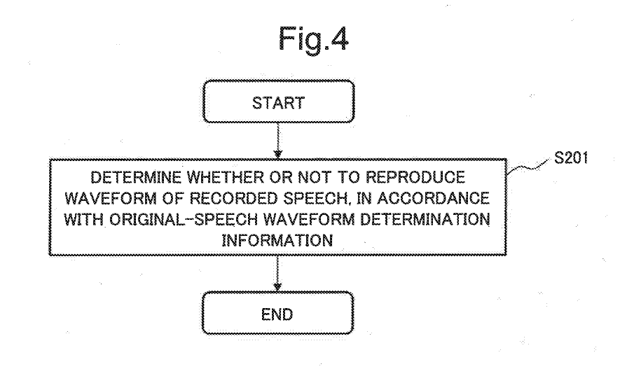

Using FIG. 4, an operation of the present example embodiment will be described. FIG. 4 is a flowchart illustrating an operation example of the original-speech waveform determination device 200 according to the second example embodiment of the present invention.

The original-speech waveform determining unit 203 determines whether or not to reproduce a waveform of recorded speech, in accordance with original-speech waveform determination information (Step S201). Specifically, the original-speech waveform determining unit 203 determines whether or not to use original-speech waveform information for reproducing speech waveform (i.e. speech synthesis), in accordance with original-speech waveform determination information given to the original-speech waveform information.

As described above, the present example embodiment determines applicability of recorded speech to a waveform, in accordance with predetermined original-speech determination information, and therefore is able to prevent reproduction of an original-speech waveform that causes sound quality degradation. In other words, reproduction of a speech waveform can be performed without using an original-speech waveform that causes sound quality degradation, out of original-speech waveforms represented by original-speech waveform information.

Accordingly, a speech waveform not including a speech waveform represented by original-speech waveform information (i.e. an original-speech waveform) causing sound quality degradation, out of original-speech waveform information, can be reproduced. In other words, inclusion of an original-speech waveform causing sound quality degradation, out of original-speech waveforms, in a reproduced speech waveform can be prevented.

An effect of the present example embodiment will be specifically described. In general, a speech synthesis database is created by using an enormous amount of recorded speech data. Accordingly, data related to an element waveform are automatically created by a computer controlled by a program. When data related to an element waveform are created, speech quality in speech data used is not checked, and therefore a low-quality element waveform generated from unclear speech caused by noise in recording and idleness of utterance may be mixed into a generated element waveform. For example, in the technologies in aforementioned PTLs 1 and 2, when such a low-quality element waveform is included in element waveforms used for reproducing a waveform, quality of reproduced speech is significantly degraded. The present example embodiment determines applicability of recorded speech to a waveform in accordance with predetermined original-speech determination information, and therefore is able to prevent reproduction of an original-speech waveform that causes sound quality degradation.

That is to say, the present example embodiment generates highly stable synthesized speech close to human voice, and therefore is able to reproduce an original-speech waveform being a suitable element waveform.

Further a speech synthesis device using the original-speech waveform determination device 200 according to the present example embodiment is able to reproduce a suitable original-speech waveform, and therefore is able to generate highly stable synthesized speech close to human voice.

### Third Example Embodiment

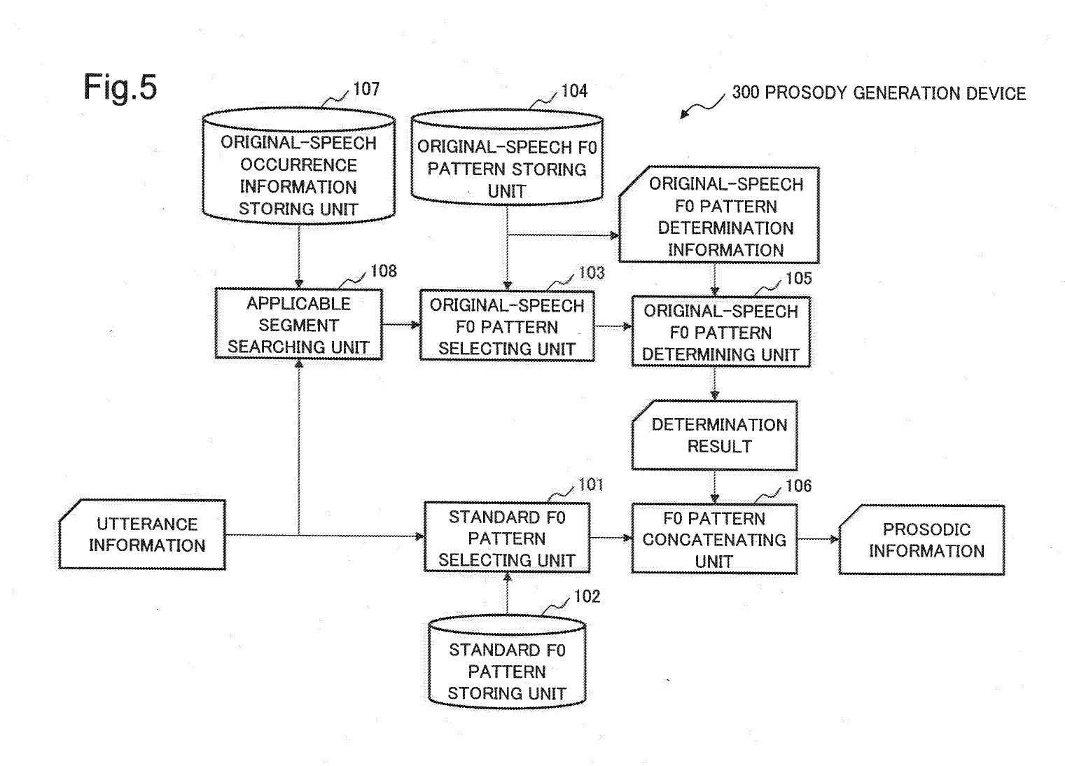

A prosody generation device being a speech processing device according to a third example embodiment will be described below. FIG. 5 is a block diagram illustrating a processing configuration example of a prosody generation device 300 according to the third example embodiment of the present invention. Referring to FIG. 5, in addition to the configuration according to the first example embodiment, the prosody generation device 300 according to the present example embodiment includes a standard F0 pattern selecting unit 101, a standard F0 pattern storing unit 102, and an original-speech F0 pattern selecting unit 103. The prosody generation device 300 further includes an F0 pattern concatenating unit 106, an original-speech utterance information storing unit 107, and an applicable segment searching unit 108.

The original-speech utterance information storing unit 107 stores original-speech utterance information representing an utterance content of recorded speech and being associated with an original-speech F0 pattern and an element waveform. For example, the original-speech utterance information storing unit 107 may store original-speech utterance information, and an identifier of an original-speech F0 pattern and an identifier of an element waveform that are associated with the original-speech utterance information.

The applicable segment searching unit 108 searches for an original-speech application target segment by checking original-speech utterance information stored in the original-speech utterance information storing unit 107 against input utterance information. In other words, the applicable segment searching unit 108 detects, as an original-speech application target segment, a part in the input utterance information that matches at least part of any piece of original-speech utterance information stored in the original-speech utterance information storing unit 107. Specifically, for example, the applicable segment searching unit 108 may divide input utterance information into a plurality of segments. The applicable segment searching unit 108 may detect, as an original-speech application target segment, a part of a segment obtained by dividing the input utterance information that matches at least part of any piece of original-speech utterance information.

The standard F0 pattern storing unit 102 stores a plurality of standard F0 patterns. Each standard F0 pattern is given attribute information. The standard F0 pattern storing unit 102 may store a plurality of standard F0 patterns and attribute information given to each of the standard F0 patterns.

The standard F0 pattern selecting unit 101 selects one standard F0 pattern for each segment obtained by dividing input utterance information, from standard F0 pattern data, in accordance with the input utterance information and attribute information stored in the standard F0 pattern storing unit 102. Specifically, for example, the standard F0 pattern selecting unit 101 may extract attribute information from each segment obtained by dividing input utterance information. The attribute information will be described later. With respect to a segment of input utterance information, the standard F0 pattern selecting unit 101 may select a standard F0 pattern to which same attribute information as attribute information of the segment is given.

The original-speech F0 pattern selecting unit 103 selects an original-speech F0 pattern related to an original-speech application target segment searched (i.e. detected) by the applicable segment searching unit 108. As will be described later, when an original-speech application target segment is detected, original-speech utterance information including a part that matches the original-speech application target segment is also specified. Then, an original-speech F0 pattern associated with the original-speech utterance information (i.e. an F0 pattern representing transition of F0 values in the original-speech utterance information) is also determined. A location of a part in the original-speech utterance information that matches the original-speech application target segment is also specified, and therefore a part, in an original-speech F0 pattern associated with the original-speech utterance information, that represents transition of F0 values in the original-speech application target segment (similarly referred to as an original-speech F0 pattern) is also determined. The original-speech F0 pattern selecting unit 103 may select an original-speech F0 pattern determined with respect to such a detected original-speech application target segment.

The F0 pattern concatenating unit 106 generates prosodic information of synthesized speech by concatenating a selected standard F0 pattern with an original-speech F0 pattern.

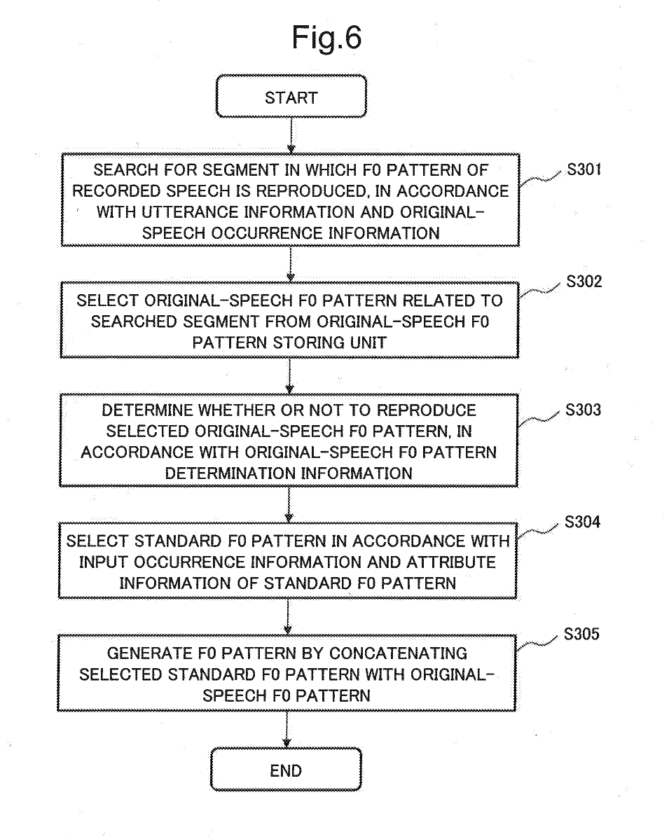

Using FIG. 6, an operation of the present example embodiment will be described. FIG. 6 is a flowchart illustrating an operation example of the prosody generation device 300 according to the third example embodiment of the present invention.

The applicable segment searching unit 108 searches for an original-speech application target segment by checking original-speech utterance information stored in the original-speech utterance information storing unit 107 against input utterance information. In other words, the applicable segment searching unit 108 searches for, in the input utterance information, a segment in which an F0 pattern of recorded speech is reproduced as prosodic information of synthesized speech (i.e. an original-speech application target segment), in accordance with the input utterance information and the original-speech utterance information (Step S301).

The original-speech F0 pattern selecting unit 103 selects an original-speech F0 pattern related to the original-speech application target segment searched and detected by the applicable segment searching unit 108, from original-speech F0 patterns stored in the original-speech F0 pattern storing unit (Step S302).

An original-speech F0 pattern determining unit 105 determines whether or not to reproduce the selected original-speech F0 pattern as prosodic information of synthesized speech, in accordance with original-speech F0 pattern determination information stored in the original-speech F0 pattern storing unit 104 (Step S303). Specifically, the original-speech F0 pattern determining unit 105 determines whether or not to reproduce the selected original-speech F0 pattern as prosodic information of synthesized speech, in accordance with original-speech F0 pattern determination information associated with the selected original-speech F0 pattern. The original-speech F0 pattern being related to the original-speech application target segment and being selected in Step S302 is an original-speech F0 pattern selected as an F0 pattern of speech data to be synthesized by speech synthesis (i.e. synthesized speech) in a segment corresponding to the original-speech application target segment. Accordingly, in other words, the original-speech F0 pattern determining unit 105 determines whether or not to apply an original-speech F0 pattern to speech synthesis, in accordance with original-speech F0 pattern determination information associated with the original-speech F0 pattern selected as an F0 pattern of speech data to be synthesized by the speech synthesis.

The standard F0 pattern selecting unit 101 selects one standard F0 pattern for each segment obtained by dividing the input utterance information, from standard F0 patterns, in accordance with the input utterance information and attribute information stored in the standard F0 pattern storing unit 102 (Step S304).

The F0 pattern concatenating unit 106 generates an F0 pattern of synthesized speech (i.e. prosodic information) by concatenating the standard F0 pattern selected by the standard F0 pattern selecting unit 101 with the original-speech F0 pattern (Step S305).

The standard F0 pattern selecting unit 101 may select a standard F0 pattern with respect to a segment not determined as an original-speech application target segment by the applicable segment searching unit 108.

As described above, the present example embodiment determines applicability in accordance with predetermined original-speech F0 pattern determination information, and uses a standard F0 pattern in an inapplicable segment and an unapplied segment. Consequently, highly stable prosody can be generated while preventing reproduction of an original-speech F0 pattern that causes degradation of naturalness of prosody.

### Fourth Example Embodiment

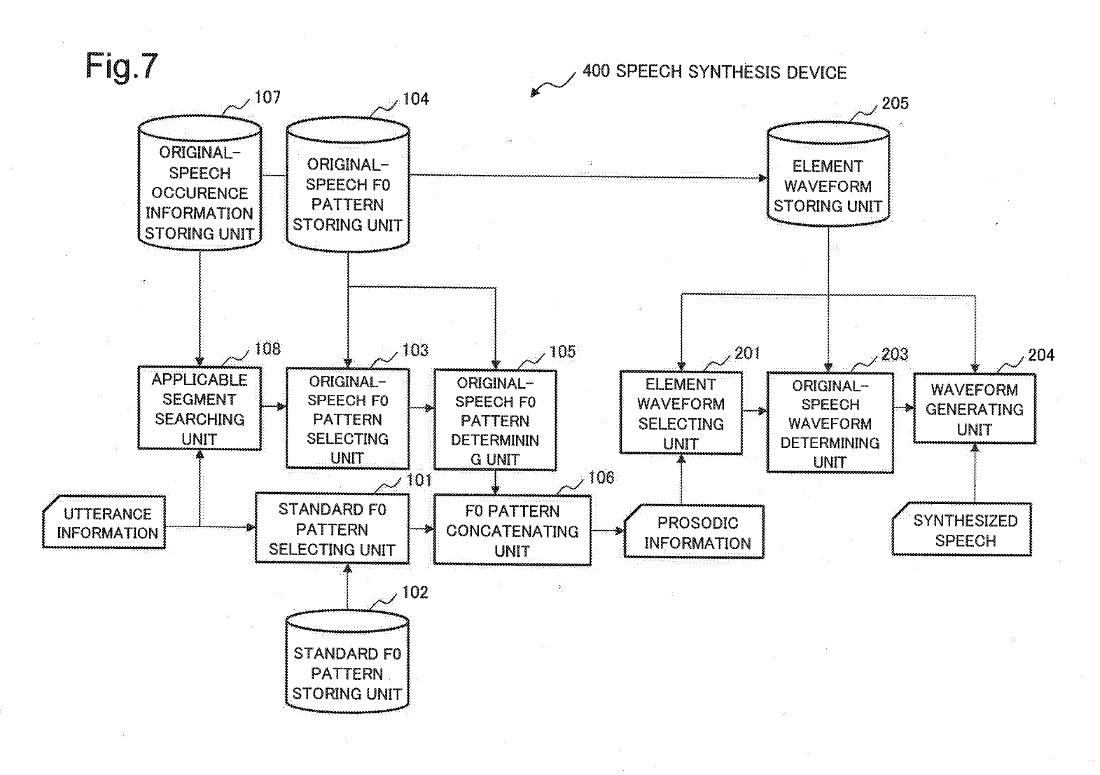

A fourth example embodiment of the present invention will be described below. FIG. 7 is a diagram illustrating an overview of a speech synthesis device 400 being a speech processing device according to the fourth example embodiment of the present invention.

The speech synthesis device 400 according to the present example embodiment includes a standard F0 pattern selecting unit 101 (second selecting unit), a standard F0 pattern storing unit 102 (third storing unit), and an original-speech F0 pattern selecting unit 103 (first selecting unit). The speech synthesis device 400 further includes an original-speech F0 pattern storing unit 104 (first storing unit), an original-speech F0 pattern determining unit 105 (first determining unit), and an F0 pattern concatenating unit 106 (concatenating unit). The speech synthesis device 400 further includes an original-speech utterance information storing unit 107 (second storing unit), an applicable segment searching unit 108 (searching unit), and an element waveform selecting unit 201 (third selecting unit). The speech synthesis device 400 further includes an element waveform storing unit 205 (fourth storing unit), an original-speech waveform determining unit 203 (third determining unit), and a waveform generating unit 204.

For example, a “storing unit” according to the respective example embodiments of the present invention is implemented with a storage device. In description of the respective example embodiments of the present invention, “a storing unit storing information” refers to the information being recorded in the storing unit. For example, the storing units according to the present example embodiment includes the standard F0 pattern storing unit 102, the original-speech F0 pattern storing unit 104, the original-speech utterance information storing unit 107, and the element waveform storing unit 205. A storing unit to which another designation is given exists, according to another example embodiment of the present invention.

The original-speech utterance information storing unit 107 stores original-speech utterance information representing an utterance content of recorded speech. The original-speech utterance information is associated with an original-speech F0 pattern and an element waveform to be respectively described later. For example, the original-speech utterance information includes phoneme string information of recorded speech, accent information of recorded speech, and pause information of recorded speech. For example, the original-speech utterance information may further include additional information such as word separation information, part of speech information, phrase information, accent phrase information, and emotional expression information. For example, the original-speech utterance information storing unit 107 may store a small amount of original-speech utterance information. It is assumed that the original-speech utterance information storing unit 107 according to the present example embodiment stores, for example, original-speech utterance information of utterance contents of several hundred sentences or more.

In description of the present example embodiment, for example, recorded speech refers to speech recorded as speech used for speech synthesis. Phoneme string information refers to a time series of phonemes in recorded speech (i.e. a phoneme string).

For example, accent information refers to a position in a phoneme string where a pitch sharply drops. For example, pause information refers to a position of a pause in a phoneme string. For example, word separation information refers to a boundary between words in a phoneme string. For example, part of speech information refers to each part of speech of a word separated by word separation information. For example, phrase information refers to a separation of a phrase in a phoneme string. For example, accent phrase information refers to a separation of an accent phrase in a phoneme string. For example, an accent phrase refers to a speech phrase expressed as a group of accents. For example, emotional expression information refers to information indicating an emotion of a speaker in recorded speech.

For example, the original-speech utterance information storing unit 107 may store original-speech utterance information, a node number (to be described later) of an original-speech F0 pattern associated with the original-speech utterance information, and an identifier of an element waveform associated with the original-speech information. The node number of an original-speech F0 pattern is an identifier of an original-speech F0 pattern.

As will be described later, the original-speech F0 pattern refers to transition of values of F0 (also referred to as F0 values) extracted from recorded speech. An original-speech F0 pattern associated with original-speech utterance information refers to transition of F0 values extracted from recorded speech an utterance content of which is represented by the original-speech utterance information. For example, the original-speech F0 pattern is a set of continuous F0 values extracted from recorded speech at predetermined intervals. For example, according to the present example embodiment, a position in recorded speech where an F0 value is extracted is also referred to as a node. For example, each F0 value included in an original-speech F0 pattern is given a node number indicating an order of nodes. The node number may be uniquely given to a node. The node number is associated with an F0 value at a node indicated by the node number. For example, an original-speech F0 pattern is specified by a node number associated with the first F0 value included in the original-speech F0 pattern and a node number associated with the last F0 value in the original-speech F0 pattern. Original-speech utterance information may be associated with an original-speech F0 pattern so that a part of the original-speech F0 pattern in a continuous part of the original-speech utterance information (hereinafter also referred to as a segment) can be specified. For example, each phoneme in original-speech utterance information may be associated with one or more node numbers in an original-speech F0 pattern (e.g. the first and last F0 values included in a segment associated with the phoneme).

Original-speech utterance information may be associated with an element waveform so that a waveform in a segment of the original-speech utterance information can be reproduced by concatenating element waveforms. As will be described later, for example, the element waveform is generated by dividing recorded speech. For example, original-speech utterance information may associate an identifier of an element waveform generated by dividing recorded speech an utterance content of which is represented by the original-speech utterance information with a string of element waveform identifiers arranged in an order before the division. Further, for example, a separation of a phoneme may be associated with a separation in a string of element waveform identifiers.

First, utterance information is input to the applicable segment searching unit 108. The utterance information includes phoneme string information, accent information, and pause information respectively representing speech to be synthesized. For example, the utterance information may further include additional information such as word separation information, part of speech information, phrase information, accent phrase information, and emotional expression information. Further, the utterance information may be autonomously generated by, for example, an information processing device configured to generate utterance information, or the like. The utterance information may be manually generated by, for example, an operator. The utterance information may be generated by any method. By checking input utterance information against original-speech utterance information stored in the original-speech utterance information storing unit 107, the applicable segment searching unit 108 selects a segment matching the input utterance information (hereinafter referred to as an original-speech application target segment), in the original-speech utterance information. For example, the applicable segment searching unit 108 may extract an original-speech application target segment for each predetermined type of section such as a word, a phrase, or an accent phrase. For example, the applicable segment searching unit 108 determines a match between input utterance information and a segment in original-speech utterance information by determining a match of an anterior-posterior environment of accent information and a phoneme, and the like, in addition to a match of phoneme strings. The utterance information according to the present example embodiment refers to an utterance in Japanese. The applicable segment searching unit 108 searches for an applicable segment for each accent phrase with Japanese as a target.

Specifically, for example, the applicable segment searching unit 108 may divide input utterance information into accent phrases. Original-speech utterance information may be previously divided into accent phrases. The applicable segment searching unit 108 may further divide the original-speech utterance information into accent phrases. For example, the applicable segment searching unit 108 may perform morphological analysis on phoneme strings indicated by phoneme string information of input utterance information and original-speech utterance information, and, by using the result, estimate accent phrase boundaries. Then, by dividing the phoneme strings of the input utterance information and the original-speech utterance information at estimated accent phrase boundaries, the applicable segment searching unit 108 may divide the input utterance information and the original-speech utterance information into accent phrases. When utterance information includes accent phrase information, by dividing a phoneme string indicated by phoneme string information of the utterance information at an accent phrase boundary indicated by the accent phrase information, the applicable segment searching unit 108 may divide the utterance information into accent phrases. The applicable segment searching unit 108 may compare an accent phrase obtained by dividing input utterance information (hereinafter referred to as an input accent phrase) with an accent phrase obtained by dividing original-speech utterance information (hereinafter referred to as an original-speech accent phrase). Then, the applicable segment searching unit 108 may select an original-speech accent phrase similar to (e.g. partially matching) an input accent phrase as an original-speech accent phrase related to the input accent phrase. In an original-speech accent phrase related to an input accent phrase, the applicable segment searching unit 108 detects a segment matching at least part of the input accent phrase. In the following description, original-speech utterance information is previously divided into accent phrases. In other words, the aforementioned original-speech accent phrases are stored in the original-speech utterance information storing unit 107 as original-speech utterance information.

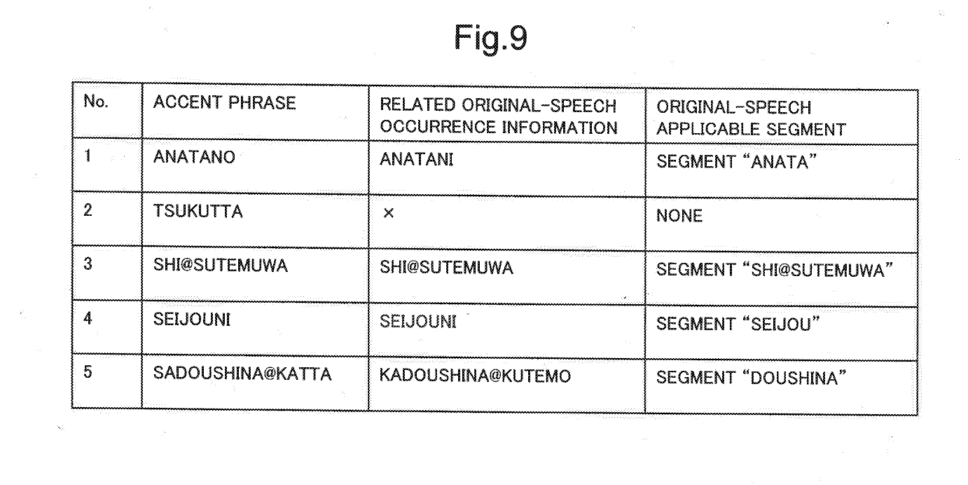

As a specific example of input utterance information, a case of Japanese utterance information “ANATANO/TSUKUTTA/SHI@SUTEMUWA/PAUSE/SEIJOUNI/S ADOUSHINA@KATTA (Japanese) [The system you had built did not operate properly.]” being input will be described below. Note that “/” denotes a separation of an accent phrase, “@” denotes an accent position, and “PAUSE” denotes a silent segment (pause). A processing result by the applicable segment searching unit 108 in this case is illustrated in FIG. 9. In the example illustrated in FIG. 9, “NO.” denotes a number of an input accent phrase. Further, “ACCENT PHRASE” denotes an input accent phrase. Further, “RELATED ORIGINAL-SPEECH UTTERANCE INFORMATION” denotes original-speech utterance information selected as original-speech utterance information related to an input accent phrase. “RELATED ORIGINAL-SPEECH UTTERANCE INFORMATION” being “×” indicates that original-speech utterance information similar to the input accent phrase is not detected. Further, “ORIGINAL-SPEECH APPLICABLE SEGMENT” denotes the aforementioned original-speech applicable segment selected by the applicable segment searching unit 108. As indicated in FIG. 9, the first accent phrase is “ANATANO,” (Japanese) and related original-speech utterance information is “ANATANI.” (Japanese)

The applicable segment searching unit 108 selects a segment “ANATA” as an original-speech application target segment of the first accent phrase. Similarly, the applicable segment searching unit 108 selects “NONE” indicating nonexistence of an original-speech application target segment as an original-speech application target segment of the second accent phrase. The applicable segment searching unit 108 selects a segment “SHI@SUTEMUWA” (Japanese) as an original-speech application target segment of the third accent phrase. The applicable segment searching unit 108 selects a segment “SEIJOU” (Japanese) as an original-speech application target segment of the fourth accent phrase. The applicable segment searching unit 108 selects a segment “DOUSHINA@” (Japanese) as an original-speech application target segment of the fifth accent phrase.

The standard F0 pattern storing unit 102 stores a plurality of standard F0 patterns. Each standard F0 pattern is given attribute information. For example, the standard F0 pattern is data approximately representing a form of an F0 pattern in a segment divided at a predetermined separation such as a word, an accent phrase, or a breath group, by several to several tens of control points. For example, the standard F0 pattern storing unit 102 may store, as control points of a standard F0 pattern in an utterance in Japanese, nodes on a spline curve approximating a waveform of the standard F0 pattern as a standard F0 pattern for each accent phrase. Attribute information of a standard F0 pattern is linguistic information related to a form of an F0 pattern. For example, when a standard F0 pattern is a standard F0 pattern in an utterance in Japanese, attribute information of the standard F0 pattern is information indicating an attribute of an accent phrase, such as “5 morae, type 4/an end of a sentence/declarative sentence.” Thus, an attribute of an accent phrase may be, for example, a combination of phonemic information indicating a number of morae in the accent phrase and an accent position, a position of the accent phrase in a sentence including the accent phrase, a type of sentence including the accent phrase, and the like. Such attribute information is given to each standard F0 pattern.

The standard F0 pattern selecting unit 101 selects one standard F0 pattern for each segment obtained by dividing input utterance information, in accordance with the input utterance information and attribute information stored in the standard F0 pattern storing unit 102. The standard F0 pattern selecting unit 101 may first divide the input utterance information at a same type of separation as a separation in a standard F0 pattern. The standard F0 pattern selecting unit 101 may derive attribute information of each segment obtained by dividing the input utterance information (hereinafter referred to as a divided segment). The standard F0 pattern selecting unit 101 may select a standard F0 pattern associated with same attribute information as attribute information of each divided segment, from standard F0 patterns stored in the standard F0 pattern storing unit 102. When input utterance information represents an utterance in Japanese, for example, the standard F0 pattern selecting unit 101 may divide the input utterance information into accent phrases by dividing the input utterance information at a boundary of an accent phrase.

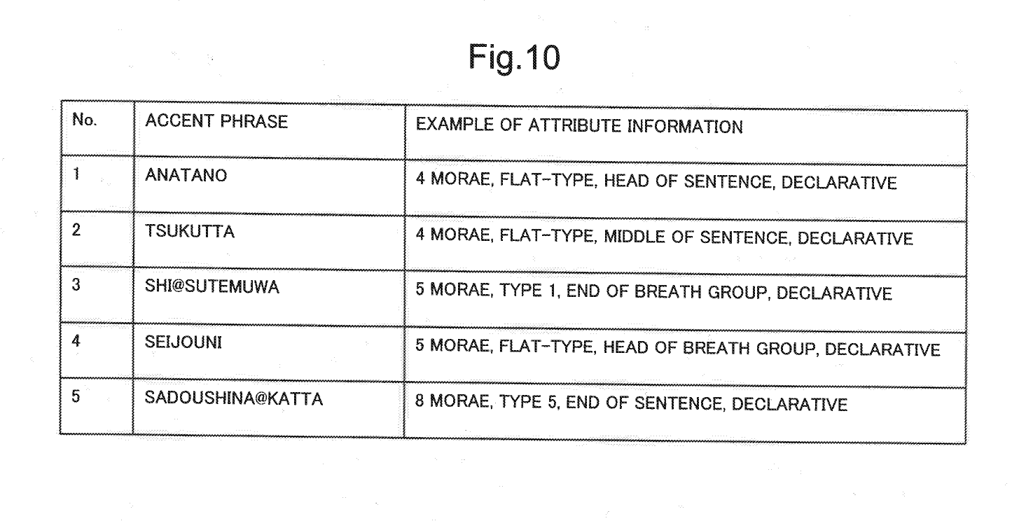

The above will be described by using a specific example. FIG. 10 indicates attribute information of each accent phrase in input utterance information. In the aforementioned example of utterance information, the standard F0 pattern selecting unit 101 divides the input utterance information into, for example, accent phrases indicated in FIG. 10. Then, for example, the standard F0 pattern selecting unit 101 extracts an attribute as exemplified in “ATTRIBUTE INFORMATION EXAMPLE” in FIG. 10 for each accent phrase generated by the division. The standard F0 pattern selecting unit 101 selects a standard F0 pattern with matching attribute information for each accent phrase.

For example, in the example in FIG. 10, attribute information of an accent phrase “ANATANO” (Japanese) is “4 morae, flat-type, a head of a sentence, declarative.” The standard F0 pattern selecting unit 101 selects a standard F0 pattern associated with the attribute information “4 morae, flat-type, a head of a sentence, declarative” with respect to the accent phrase “ANATANO.” (Japanese) In the attribute information indicated in FIG. 10, “declarative” refers to a “declarative sentence.”

The original-speech F0 pattern storing unit 104 stores a plurality of original-speech F0 patterns. Each original-speech F0 pattern is given original-speech F0 pattern determination information. The original-speech F0 pattern is an F0 pattern extracted from recorded speech. For example, the original-speech F0 pattern includes a set (e.g. a string) of values of F0 (i.e. F0 values) extracted at certain intervals (e.g. approximately 5 msec). The original-speech F0 pattern further includes phoneme label information being associated with an F0 value and indicating a phoneme in recorded speech from which the F0 value is derived. Further, an F0 value is associated with a node number indicating an order of a position where the F0 value is extracted in a recorded speech source. When an original-speech F0 pattern is expressed by a broken line, an extracted F0 value is indicated as a node of the broken line. According to the present example embodiment, a standard F0 pattern approximately represents a form, while an original-speech F0 pattern includes information by which original recorded speech is fully reproducible.

Further, an original-speech F0 pattern may be stored in a same segment as a segment in which each standard F0 pattern is stored. The original-speech F0 pattern may be associated with original-speech utterance information of a same segment as the segment of the original-speech F0 pattern, the information being stored in the original-speech utterance information storing unit 107.

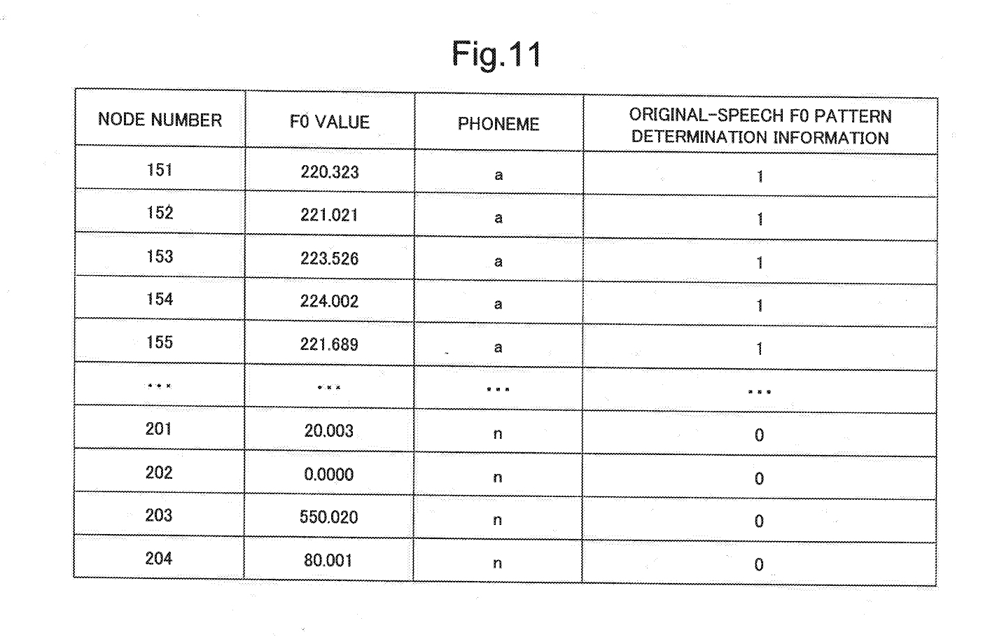

Original-speech F0 pattern determination information is information indicating whether or not to use an original-speech F0 pattern associated with the original-speech F0 pattern determination information for speech synthesis. The original-speech F0 pattern determination information is used for determining whether or not to apply an original-speech F0 pattern to speech synthesis. FIG. 11 illustrates an example of a storage format of an original-speech F0 pattern. FIG. 11 indicates a part “ANA (TANI)” (Japanese) of an original-speech application target segment. For example, as illustrated in FIG. 11, the original-speech F0 pattern storing unit 104 stores a node number, an F0 value, phoneme information, and original-speech F0 pattern determination information, for each node. Additionally, as described above, each node number indicating an original-speech F0 pattern of original-speech utterance information is associated with the original-speech utterance information. By comparing phoneme information for each node in an original-speech F0 pattern of original-speech utterance information including an original-speech application target segment in a range thereof with phoneme information in the original-speech application target segment, a range of node numbers of F0 values in the original-speech application target segment can be specified. Accordingly, when an original-speech application target segment is specified, an original-speech F0 pattern related to the original-speech application target segment (i.e. an F0 pattern representing transition of F0 values in the original-speech application target segment) can also be specified.

The original-speech F0 pattern selecting unit 103 selects an original-speech F0 pattern related to an original-speech application target segment selected by the applicable segment searching unit 108. When a plurality of pieces of related original-speech utterance information are selected with respect to an original-speech application target segment, the original-speech F0 pattern selecting unit 103 may select respective original-speech F0 patterns related to the pieces of original-speech utterance information. That is to say, when a plurality of original-speech F0 patterns related to original-speech utterance information having matching utterance information exist in an original-speech application target segment, the original-speech F0 pattern selecting unit 103 may select the plurality of original-speech F0 patterns.

The original-speech F0 pattern determining unit 105 determines whether or not to use a selected original-speech F0 pattern for speech synthesis, in accordance with original-speech F0 pattern determination information stored in the original-speech F0 pattern storing unit 104. As illustrated in FIG. 11, an applicability flag represented by 0 or 1 is given to an original-speech F0 pattern for each predetermined segment (e.g. a node) as original-speech F0 pattern determination information according to the present example embodiment. In the example illustrated in FIG. 11, an applicability flag given to an original-speech F0 pattern for each node is associated with an F0 value at a node to which the applicability flag is given, as original-speech F0 pattern determination information. In description of the present example embodiment, when an applicability flag associated with every F0 value included in an original-speech F0 pattern is “1,” the applicability flags indicate that the original-speech F0 pattern is used.

When any of applicability flags associated with F0 values included in an original-speech F0 pattern is “0,” the applicability flag indicates that the original-speech F0 pattern is not used. For example, at a node with a node number “151,” an F0 value is “220.323,” a phoneme is “a,” and original-speech F0 pattern determination information is “1.” In other words, an applicability flag being original-speech F0 pattern determination information is 1. When an original-speech F0 pattern is represented by F0 values with applicability flags being 1, as is the case with the F0 value with the node number “151,” the applicability flag is 1, and therefore the original-speech F0 pattern determining unit 105 determines to use the original-speech F0 pattern. As indicated in FIG. 11, an original-speech F0 pattern at the node with the node number “151” has an F0 value “220.323.” Further, for example, at a node with a node number “201,” an F0 value is “20.003,” a phoneme is “n,” and original-speech F0 pattern determination information is “0.” In other words, an applicability flag being original-speech F0 pattern determination information is “0.” When an original-speech F0 pattern at the node with the node number “201” is selected, the applicability flag is 0, and therefore the original-speech F0 pattern determining unit 105 determines not to use the original-speech F0 pattern at the node with the node number “201.” As indicated in FIG. 11, the original-speech F0 pattern at the node with the node number “201” has an F0 value “20.003.”

When a plurality of original-speech F0 patterns are selected, the original-speech F0 pattern determining unit 105 determines whether or not to use the original-speech F0 pattern for each original-speech F0 pattern, in accordance with applicability flags associated with F0 values representing the original-speech F0 pattern. For example, when every applicability flag associated with F0 values representing an original-speech F0 pattern is 1, the original-speech F0 pattern determining unit 105 determines to use the original-speech F0 pattern. When any of applicability flags associated with F0 values representing an original-speech F0 pattern is not 1, the original-speech F0 pattern determining unit 105 determines not to use the original-speech F0 pattern. The original-speech F0 pattern determining unit 105 may determine to use two or more original-speech F0 patterns.

For example, out of F0 values with node numbers from “151” to “204” indicated in FIG. 11, original-speech F0 pattern determination information being applicability flags of F0 values with node numbers from “201” to “204” is “0.” In other words, in the example illustrated in FIG. 11, an applicability flag for an F0 value with a phoneme “n” is “0.” In the example illustrated in FIG. 9, “ANATANI” (Japanese) is selected as original-speech utterance information related to the first accent phrase “ANATANO.” (Japanese) Further, the segment “ANATA” (Japanese) is selected as an original-speech applicable segment.

For example, when an original-speech F0 pattern of a part “ANA (TANI)” (Japanese) of the original-speech application target segment indicated in FIG. 9 is the original-speech F0 pattern indicated in FIG. 11, the original-speech F0 pattern includes F0 values with applicability flags being “0.” Specifically, as described above, F0 values with phonemes being “n” out of the original-speech F0 pattern indicated in FIG. 11 has applicability flags “0.” Accordingly, the original-speech F0 pattern determining unit 105 determines not to use the original-speech F0 pattern indicated in FIG. 11 for speech synthesis with respect to the first accent phrase “ANATANO.” (Japanese)

For example, an applicability flag may be given when extracting F0 from recorded speech data (e.g. when extracting an F0 value from recorded speech data at predetermined intervals), in accordance with a predetermined method (or a rule). The method of determining an applicability flag to be given may be previously determined so that an original-speech F0 pattern unsuitable for speech synthesis is given “0” as an applicability flag, and an original-speech F0 pattern suitable for speech synthesis is given “1” as an applicability flag. The original-speech F0 pattern unsuitable for speech synthesis refers to an F0 pattern by which natural synthesized speech is not likely to be obtained when the original-speech F0 pattern is used for speech synthesis.

Specifically, for example, the method of determining an applicability flag to be given includes a method based on an extracted F0 frequency. For example, when an extracted F0 frequency is not included in an F0 frequency range typically extracted from human speech (e.g. 50 to 500 Hz), “0” may be given as an applicability flag to an original-speech F0 pattern indicating the extracted F0. The F0 frequency range typically extracted from human speech is hereinafter referred to as an “expected F0 range.” When an extracted F0 frequency (i.e. an F0 value) is included in the expected F0 range, “1” may be given as an applicability flag to the F0 value. Further, for example, the method of giving an applicability flag includes a method based on phoneme label information. For example, “0” may be given as an applicability flag to an F0 value indicating F0 extracted in an unvoiced segment indicated by phoneme label information. Further, “1” may be given as an applicability flag to an F0 value extracted in a voiced segment indicated by phoneme label information. When F0 is not extracted in a voiced segment indicated by phoneme label information (e.g. an F0 value is 0, or an F0 value is not included in the aforementioned expected F0 range), “0” may be given as an applicability flag to the F0 value. For example, an operator may manually give an applicability flag in accordance with a predetermined method. For example, a computer may give an applicability flag in accordance with control by a program configured to give an applicability flag in accordance with a predetermined method. An operator may manually correct an applicability flag given by a computer. The methods of giving an applicability flag are not limited to the aforementioned examples.

The F0 pattern concatenating unit 106 generates prosodic information of synthesized speech by concatenating a selected standard F0 pattern with a selected original-speech F0 pattern. For example, the F0 pattern concatenating unit 106 may translate a selected standard F0 pattern or a selected original-speech F0 pattern in an F0 frequency axis direction so that endpoint pitch frequencies of the standard F0 pattern and the original-speech F0 pattern match. When a plurality of original-speech F0 patterns are selected as candidates, the F0 pattern concatenating unit 106 selects one of the original-speech F0 patterns and then concatenates a selected standard F0 pattern with the original-speech F0 pattern. For example, the F0 pattern concatenating unit 106 may select an original-speech F0 pattern from a plurality of selected original-speech F0 patterns, in accordance with at least either of a ratio or a difference between a peak value of a standard F0 pattern and a peak value of an original-speech F0 pattern. For example, the F0 pattern concatenating unit 106 may select an original-speech F0 pattern making the ratio minimum. The F0 pattern concatenating unit 106 may select an original-speech F0 pattern making the difference minimum.

Prosodic information is generated as described above. The generated prosodic information according to the present example embodiment is an F0 pattern including a plurality of F0 values, representing transition of F0 at every certain time, and being associated with phonemes. The F0 pattern includes F0 values at every certain time, being associated with phonemes, and therefore is expressed in a form capable of specifying duration of each phoneme. However, the prosodic information may be expressed in a form that does not include duration information of each phoneme. For example, the F0 pattern concatenating unit 106 may generate duration of each phoneme as information separate from the prosodic information. Further, the prosodic information may include power of a speech waveform.

The element waveform storing unit 205 stores, for example, a large number of element waveforms created from recorded speech. Each element waveform is given attribute information and original-speech waveform determination information. In addition to an element waveform, the element waveform storing unit 205 may store attribute information and original-speech waveform determination information that are given to the element waveform and associated with the element waveform. The element waveform is a short-time waveform extracted from original speech (e.g. recorded speech), as a unit waveform with a specific length, in accordance with a specific rule. The element waveform may be generated by dividing original speech in accordance with a specific rule. For example, the element waveform includes unit element waveforms such as consonant (C) vowel (V), VC, CVC, and VCV in Japanese. The element waveform is a waveform extracted from a recorded speech waveform. Accordingly, for example, when element waveforms are generated by dividing original speech, the original-speech waveform can be reproduced by concatenating the element waveforms in an order of the element waveforms before the division. Note that, in the description above, a “waveform” refers to data representing a speech waveform.

Attribute information of each element waveform, according to the present example embodiment, may be attribute information used in common unit selection type speech synthesis. For example, the attribute information of each element waveform may include at least any of phoneme information, and spectral information represented by cepstrum or the like, original F0 information, and the like. For example, the original F0 information may indicate an F0 value extracted in an element waveform part in speech from which the element waveform is extracted, and a phoneme. Further, original-speech waveform determination information is information indicating whether or not an element waveform of original speech associated with the original-speech waveform determination information is used for speech synthesis. For example, original-speech waveform determination information is used by the original-speech waveform determining unit 203 for determining whether or not to use element information of original speech associated with the original speech determination information for speech synthesis.

The element waveform selecting unit 201 selects an element waveform used for waveform generation, in accordance with, for example, input utterance information, generated prosodic information, and attribute information of an element waveform stored in the element waveform storing unit 205.

Specifically, for example, the element waveform selecting unit 201 compares phoneme string information and prosodic information that are included in utterance information of an extracted original-speech application target segment with phoneme information and prosodic information (e.g. spectral information or original F0 information) included in attribute information of an element waveform. Then, the element waveform selecting unit 201 indicates a phoneme string matching a phoneme string in the original-speech application target segment, and extracts an element waveform to which attribute information including prosodic information similar to prosodic information of the original-speech application target segment is given. For example, the element waveform selecting unit 201 may determine prosodic information a distance of which from prosodic information of the original-speech application target segment is less than a threshold value as prosodic information similar to the prosodic information of the original-speech application target segment. For example, the element waveform selecting unit 201 may specify F0 values (i.e. an F0 value string) at every certain time in prosodic information of the original-speech application target segment and prosodic information included in attribute information of the element waveform (i.e. prosodic information of the element waveform). The element waveform selecting unit 201 may calculate a distance of the specified F0 value string as the aforementioned distance of prosodic information. The element waveform selecting unit 201 may successively select one F0 value from the F0 value string specified in the prosodic information of the original-speech application target segment, and successively select one F0 value from the F0 value string in the prosodic information of the element waveform. For example, the element waveform selecting unit 201 may calculate, as a distance between the two F0 value strings, a cumulative sum of absolute differences, a square root of a cumulative sum of squared differences, or the like of two F0 values selected from the strings. The method of selecting an element waveform by the element waveform selecting unit 201 is not limited to the example above.

The original-speech waveform determining unit 203 determines whether or not to reproduce an original recorded speech waveform by using an element waveform in an original-speech application target segment, in accordance with original-speech waveform determination information associated with the element waveform stored in the element waveform storing unit 205. According to the present example embodiment, an applicability flag represented by 0 or 1 is previously given to each unit element waveform as original-speech waveform determination information. When an applicability flag being original-speech waveform determination information is 1 in an original-speech application target segment, the original-speech waveform determining unit 203 determines to use an element waveform associated with the original-speech waveform determination information for speech synthesis. When a value of an applicability flag of a selected original-speech F0 pattern is 1, the original-speech waveform determining unit 203 applies an element waveform associated with the original-speech waveform determination information to the selected original-speech F0 pattern. When an applicability flag being original-speech waveform determination information is 0 in an original-speech application target segment, the original-speech waveform determining unit 203 determines not to use an element waveform associated with the original-speech waveform determination information for speech synthesis. The original-speech waveform determining unit 203 performs the processing described above regardless of a value of an applicability flag of a selected original-speech F0 pattern. Accordingly, the speech synthesis device 400 is able to reproduce speech of original speech by using only either of an F0 pattern or an element waveform.

In the example above, when a value of an applicability flag being original-speech waveform determination information is 1, the original-speech waveform determination information indicates that an element waveform associated with the original-speech waveform determination information is used. When a value of an applicability flag being original-speech waveform determination information is 0, the original-speech waveform determination information indicates that an element waveform associated with the original-speech waveform determination information is not used. A value of an applicability flag may be different from the values in the example above.

For example, an applicability flag given to an element waveform may be determined by using a result of previous analysis on each element waveform so that, when an element waveform is used for speech synthesis and natural synthesized speech cannot be obtained, “0” is given to the element waveform, otherwise “1” is given. The applicability flag given to an element waveform may be given by a computer or the like implemented to give an applicability flag value, or manually given by an operator or the like. For example, in analysis of an element waveform, a distribution based on spectral information of element waveforms with same attribute information may be generated. Then, an element waveform significantly deviating from a centroid of the generated distribution may be specified, and the specified element waveform may be given 0 as an applicability flag. For example, the applicability flag given to the element waveform may be manually corrected. Alternatively, the applicability flag given to the element waveform may be automatically corrected by another method by a computer implemented to correct an applicability flag in accordance with a predetermined method, or the like.

The waveform generating unit 204 generates synthesized speech by editing selected element waveforms in accordance with generated prosodic information, and concatenating the element waveforms. As the generation method of synthesized speech, various methods generating synthesized speech in accordance with prosodic information and an element waveform may be applied.

The element waveform storing unit 205 may store element waveforms related to all original-speech F0 patterns stored in the original-speech F0 pattern storing unit 104. However, the element waveform storing unit 205 does not necessarily need to store element waveforms related to all original-speech F0 patterns. In that case, when the original-speech waveform determining unit 203 determines that an element waveform related to a selected original-speech F0 pattern does not exist, the waveform generating unit 204 may not reproduce original speech by an element waveform.

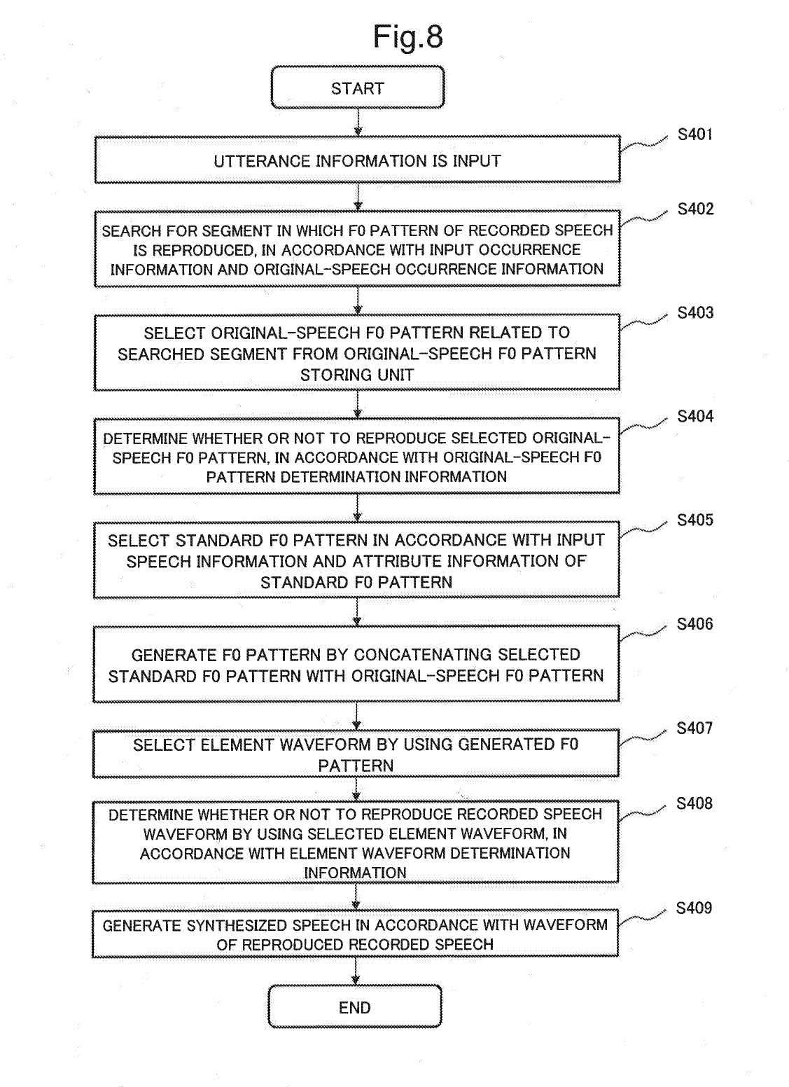

Using FIG. 8, an operation of the speech synthesis device 400 according to the present example embodiment will be described. FIG. 8 is a flowchart illustrating an operation example of the speech synthesis device 400 according to the fourth example embodiment of the present invention.

Utterance information is input to the speech synthesis device 400 (Step S401).

The applicable segment searching unit 108 extracts an original-speech application target segment by checking original-speech utterance information stored in the original-speech utterance information storing unit 107 against the input utterance information (Step S402). In other words, the applicable segment searching unit 108 checks original-speech utterance information stored in the original-speech utterance information storing unit 107 against the input utterance information. Then, the applicable segment searching unit 108 extracts, as an original-speech application target segment, a part in the input utterance information that matches at least part of the original-speech utterance information stored in the original-speech utterance information storing unit 107. For example, the applicable segment searching unit 108 may first divide the input utterance information into a plurality of segments such as accent phrases. The applicable segment searching unit 108 may search each segment generated by the division for an original-speech application target segment. A segment for which an original-speech application target segment is not extracted may exist.

The original-speech F0 pattern selecting unit 103 selects an original-speech F0 pattern related to the extracted original-speech application target segment (Step S403). That is to say, the original-speech F0 pattern selecting unit 103 selects an original-speech F0 pattern representing transition of F0 values in the extracted original-speech application target segment. In other words, the original-speech F0 pattern selecting unit 103 specifies an original-speech F0 pattern representing transition of F0 values in the extracted original-speech application target segment, in an original-speech F0 pattern of original-speech utterance information a range of which includes the original-speech application target segment.

The original-speech F0 pattern determining unit 105 determines whether or not to use the selected original-speech F0 pattern as an F0 pattern of reproduced speech data, in accordance with original-speech F0 pattern determination information associated with the original-speech F0 pattern (Step S404). In other words, the original-speech F0 pattern determining unit 105 determines whether or not to use the selected original-speech F0 pattern for speech synthesis reproducing the input utterance information as speech, in accordance with original-speech F0 pattern determination information associated with the speech F0 pattern. That is to say, the original-speech F0 pattern determining unit 105 determines whether or not to use the selected original-speech F0 pattern as an F0 pattern in reproduced speech, in accordance with original-speech F0 pattern determination information associated with the speech F0 pattern. As described above, an original-speech F0 pattern and original-speech F0 pattern determination information associated with the original-speech F0 pattern are stored in the original-speech F0 pattern storing unit 104.

The standard F0 pattern selecting unit 101 selects one standard F0 pattern for each segment generated by dividing the input utterance information, in accordance with the input utterance information and attribute information stored in the standard F0 pattern storing unit 102 (Step 405). The standard F0 pattern selecting unit 101 may select a standard F0 pattern from standard F0 patterns stored in the standard F0 pattern storing unit 102.

Thus, a standard F0 pattern is selected for each segment included in the input utterance information. Further, the segments may include a segment in which an original-speech application target segment in which an original-speech F0 pattern is further selected is selected.

The F0 pattern concatenating unit 106 generates an F0 pattern of synthesized speech (i.e. prosodic information) by concatenating a standard F0 pattern selected by the standard F0 pattern selecting unit 101 with an original-speech F0 pattern (Step S406).

Specifically, for example, as an F0 pattern for concatenation with respect to a segment not including an original-speech application target segment out of segments obtained by dividing the input utterance information, the F0 pattern concatenating unit 106 selects a standard F0 pattern selected with respect to the segment. Then, the F0 pattern concatenating unit 106 generates an F0 pattern for concatenation so that a part of the F0 pattern for concatenation with respect to the segment including the original-speech application target segment that corresponds to the original-speech application target segment is a selected original-speech F0 pattern, and the remaining part is the selected standard F0 pattern. The F0 pattern concatenating unit 106 generates an F0 pattern of synthesized speech by concatenating F0 patterns for concatenation with respect to segments obtained by dividing the input utterance information so that the F0 patterns are arranged in a same order as the order of the segments in the original utterance information.

The element waveform selecting unit 201 selects an element waveform used for speech synthesis (waveform generation in particular), in accordance with the input utterance information, the generated prosodic information, and attribute information of element waveforms stored in the element waveform storing unit 205 (Step S407).

The original-speech waveform determining unit 203 determines whether or not to reproduce an original recorded speech waveform by using an element waveform selected in an original-speech application target segment, in accordance with original-speech waveform determination information associated with the element waveform stored in the element waveform storing unit 205 (Step S408). That is to say, the original-speech waveform determining unit 203 determines whether or not to reproduce an original recorded speech waveform by using an element waveform selected in an original-speech application target segment. In other words, the original-speech waveform determining unit 203 determines whether or not to use an element waveform selected in an original-speech application target segment for speech synthesis in the original-speech application target segment, in accordance with original-speech waveform determination information associated with the element waveform.

The waveform generating unit 204 generates synthesized speech by editing and concatenating the selected element waveforms in accordance with the generated prosodic information (Step S409).

As described above, the present example embodiment determines applicability in accordance with predetermined original-speech F0 pattern determination information, and uses a standard F0 pattern for an inapplicable segment and an unapplied segment. Consequently, use of an original-speech F0 pattern that causes degradation of naturalness of prosody can be prevented. Further, highly stable prosody can be generated.

Furthermore, the present example embodiment determines whether or not to use an element waveform for a waveform of recorded speech, in accordance with predetermined original-speech determination information. Consequently, use of an original-speech waveform that causes sound quality degradation can be prevented. That is to say, the present example embodiment is able to generate highly stable synthesized speech close to human voice.

Further, when an F0 value with original-speech F0 pattern determination information being “0” exists in an original-speech F0 pattern related to an original-speech applicable segment, the present example embodiment described above does not use the original-speech F0 pattern for speech synthesis. However, when an original-speech F0 pattern includes an F0 value with original-speech F0 pattern determination information being “0,” an F0 value other than the F0 value with original-speech F0 pattern determination information being “0” may be used for speech synthesis.

### First Modified Example of Fourth Example Embodiment

A first modified example of the fourth example embodiment of the present invention will be described below. The present modified example has a configuration similar to that according to the fourth example embodiment of the present invention.

In the present modified example, an F0 value stored in an original-speech F0 pattern storing unit 104 is previously given, for example, a continuous scalar value greater than or equal to 0 as original-speech F0 pattern determination information, for each specific unit.

The aforementioned specific unit is a string of F0 values separated in accordance with a specific rule. For example, the specific unit may be an F0 value string representing an F0 pattern of a same accent phrase in Japanese. For example, the scalar value may be a numerical value indicating a degree of naturalness of generated synthesized speech when an F0 pattern represented by an F0 value string to which the scalar value is given is used for speech synthesis. In the present modified example, as the scalar value becomes greater, a degree of naturalness of synthesized speech generated by using an F0 pattern to which the scalar value is given becomes higher. The scalar value may be experimentally determined in advance.

An original-speech F0 pattern determining unit 105 determines whether or not to use a selected original-speech F0 pattern for speech synthesis, in accordance with original-speech

F0 pattern determination information stored in the original-speech F0 pattern storing unit 104. For example, the original-speech F0 pattern determining unit 105 may make a determination in accordance with a preset threshold value. For example, the original-speech F0 pattern determining unit 105 may compare original-speech F0 pattern determination information being a scalar value with a threshold value, and, as a result of the comparison, when the scalar value is greater than the threshold value, may determine to use the selected original-speech F0 pattern for speech synthesis. When the scalar value is less than the threshold value, the original-speech F0 pattern determining unit 105 determines not to use the selected original-speech F0 pattern for speech synthesis. When a plurality of original-speech F0 patterns are selected as original-speech F0 patterns having the aforementioned “matching utterance information,” the original-speech F0 pattern determining unit 105 may use original-speech F0 pattern determination information to select one original-speech F0 pattern. In that case, for example, the original-speech F0 pattern determining unit 105 may select an original-speech F0 pattern associated with a maximum original-speech F0 pattern determination information value, from the plurality of original-speech F0 patterns. Further, for example, the original-speech F0 pattern determining unit 105 may use original-speech F0 pattern determination information value for limiting a number of original-speech F0 patterns selected with respect to a same segment in input utterance information. For example, when a number of original-speech F0 patterns selected with respect to a same segment in input utterance information exceeds a threshold value, the original-speech F0 pattern determining unit 105 may exclude, for example, an original-speech F0 pattern associated with original-speech F0 pattern determination information having a minimum value from the original-speech F0 patterns selected with respect to the segment.

For example, a value of original-speech F0 pattern determination information may be automatically given by a computer or the like, or may be manually given by an operator or the like, when F0 is extracted from original recorded speech data. For example, a value of original-speech F0 pattern determination information may be a value quantifying a degree of deviation from an F0 mean value of original speech.

While original-speech F0 pattern determination information takes continuous values in the description of the present modified example above, original-speech F0 pattern determination information may take discrete values.

### Second Modified Example of Fourth Example Embodiment

A second modified example of the fourth example embodiment of the present invention will be described below. The present modified example has a configuration similar to that according to the fourth example embodiment of the present invention.

In the present modified example, a plurality of values represented by a vector are previously given for each specific unit (e.g. for each accent phrase in Japanese) as original-speech F0 pattern determination information stored in an original-speech F0 pattern storing unit 104.

An original-speech F0 pattern determining unit 105 determines whether or not to apply a selected original-speech F0 pattern to speech synthesis, in accordance with original-speech F0 pattern determination information stored in the original-speech F0 pattern storing unit 104. As a determination method, for example, the original-speech F0 pattern determining unit 105 may use a method based on a preset threshold value. The original-speech F0 pattern determining unit 105 may compare a weighted linear sum of original-speech F0 pattern determination information being a vector with a threshold value, and, when the weighted linear sum is greater than the threshold value, may determine to use the selected original-speech F0 pattern. When the weighted linear sum is less than the threshold value, the original-speech F0 pattern determining unit 105 may determine not to use the selected original-speech F0 pattern. When a plurality of original-speech F0 patterns are selected as original-speech F0 patterns having the aforementioned “matching utterance information,” the original-speech F0 pattern determining unit 105 may use original-speech F0 pattern determination information to select one original-speech F0 pattern. In that case, for example, the original-speech F0 pattern determining unit 105 may select an original-speech F0 pattern associated with a maximum original-speech F0 pattern determination information value, from the plurality of original-speech F0 patterns. Further, for example, the original-speech F0 pattern determining unit 105 may use original-speech F0 pattern determination information value for limiting a number of original-speech F0 patterns selected with respect to a same segment in input utterance information. For example, when a number of original-speech F0 patterns selected with respect to a same segment in input utterance information exceeds a threshold value, the original-speech F0 pattern determining unit 105 may exclude, for example, an original-speech F0 pattern associated with original-speech F0 pattern determination information having a minimum value from the original-speech F0 patterns selected with respect to the segment.

For example, a value of original-speech F0 pattern determination information may be automatically given by a computer or the like, or manually given by an operator or the like, when F0 is extracted from original recorded speech data. For example, a value of original-speech F0 pattern determination information may be a combination of a value indicating a degree of deviation from an F0 mean value of original speech in the first modified example and a value indicating a degree of strength of an emotion such as delight, anger, sorrow, and pleasure.

### Fifth Example Embodiment

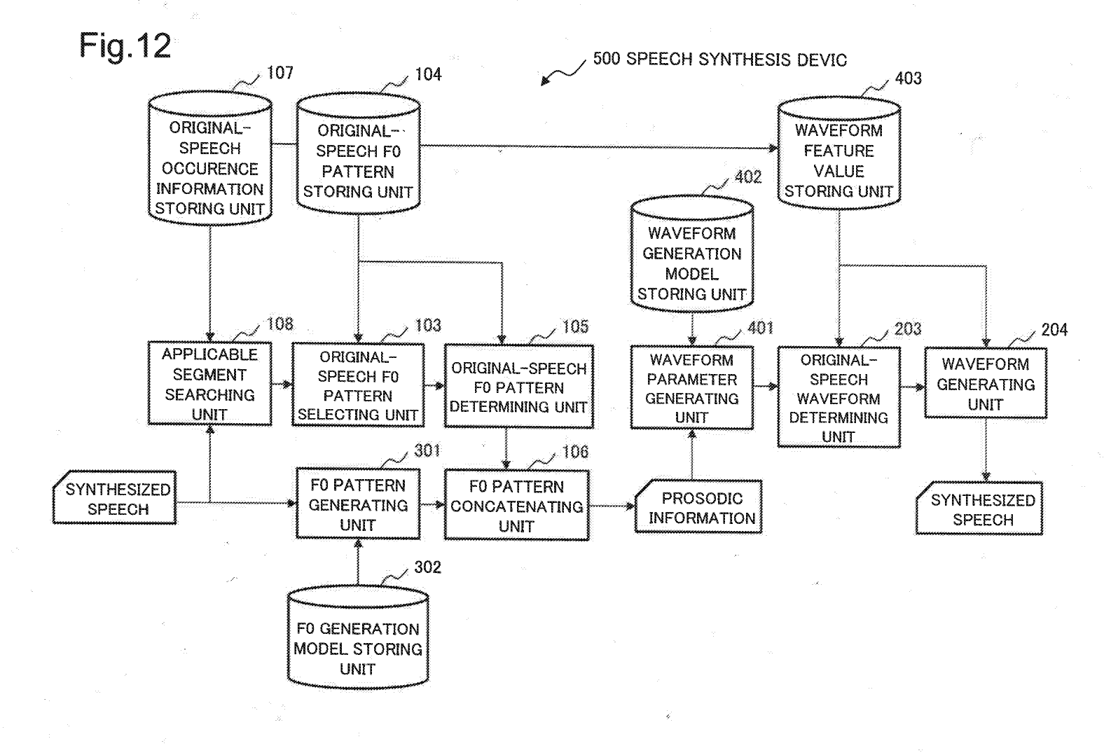

A fifth example embodiment of the present invention will be described below. FIG. 12 is a diagram illustrating an overview of a speech synthesis device 500 being a speech processing device according to the fifth example embodiment of the present invention.

As illustrated in FIG. 12, the speech synthesis device 500 according to the present example embodiment includes an F0 pattern generating unit 301 and an F0 generation model storing unit 302 in place of the standard F0 pattern selecting unit 101 and the standard F0 pattern storing unit 102 according to the fourth example embodiment. Further, the speech synthesis device 500 includes a waveform parameter generating unit 401, a waveform generation model storing unit 402, and a waveform feature value storing unit 403 in place of the element waveform selecting unit 201 and the element waveform storing unit 205 according to the fourth example embodiment.

The F0 generation model storing unit 302 stores an F0 generation model being a model for generating an F0 pattern. For example, the F0 generation model is a model that models F0 extracted from a massive amount of recorded speech by statistical learning, by using a hidden Markov model (HMM) or the like.

The F0 pattern generating unit 301 generates an F0 pattern suited to input utterance information by using an F0 generation model. The present example embodiment uses an F0 pattern generated by a similar method to the standard F0 pattern according to the fourth example embodiment. That is to say, an F0 pattern concatenating unit 106 concatenates an original-speech F0 pattern determined to be applied, by an original-speech F0 pattern determining unit 105, with a generated F0 pattern.

The waveform generation model storing unit 402 stores a waveform generation model being a model for generating a waveform generation parameter. For example, similarly to an F0 generation model, the waveform generation model is a model that models a waveform generation parameter extracted from a massive amount of recorded speech by statistical learning, by using an HMM or the like.

The waveform parameter generating unit 401 generates a waveform generation parameter by using a waveform generation model, in accordance with input utterance information and generated prosodic information.

The waveform feature value storing unit 403 stores, as original-speech waveform information, a feature value being associated with original-speech utterance information and having a same format as a waveform generation parameter. Original-speech waveform information stored in the waveform feature value storing unit 403, according to the present example embodiment, is a feature value vector being a vector of a feature value extracted from a frame generated by dividing recorded speech data by a predetermined time length (e.g. 5 msec), for each frame.

An original-speech waveform determining unit 203 determines applicability of a feature value vector in an original-speech application target segment, by a method similar to that according to the fourth example embodiment and the respective modified examples of the fourth example embodiment. When determining to apply a feature value vector, the original-speech waveform determining unit 203 replaces a generated waveform generation parameter for the relevant segment with a feature value vector stored in the waveform feature value storing unit 403. In other words, the original-speech waveform determining unit 203 may replace a generated waveform generation parameter with respect to a segment to which a feature value vector is determined to be applied with a feature value vector stored in the waveform feature value storing unit 403.

A waveform generating unit 204 generates a waveform by using a generated waveform generation parameter replaced by a feature value vector being original-speech waveform information, in a segment to which a feature value vector is determined to be applied.

For example, the waveform generation parameter is a mel-cepstrum. The waveform generation parameter may be another parameter having performance capable of roughly reproducing original speech. Specifically, for example, the waveform generation parameter may be a “STRAIGHT (described in NPL 1)” parameter having outstanding performance as an analysis-synthesis system, or the like.

### <NPL 1>

H. Kawahara, et al., “Restructuring speech representations using a pitch-adaptive time-frequency smoothing and an instantaneous-frequency-based F0 extraction,” Speech Communication, vol. 27, no. 3-4, pp. 187 to 207 (1999)

### Other Example Embodiments

For example, the speech processing device according to the respective aforementioned example embodiments is provided by circuitry. For example, the circuitry may be a computer including a memory and a processor executing a program loaded on the memory. For example, the circuitry may be two or more computers communicably connected with one another, each computer including a memory and a processor executing a program loaded on the memory. The circuitry may be a dedicated circuit. The circuitry may be two or more dedicated circuits communicably connected with one another. The circuitry may be a combination of the aforementioned computer and the aforementioned dedicated circuit.

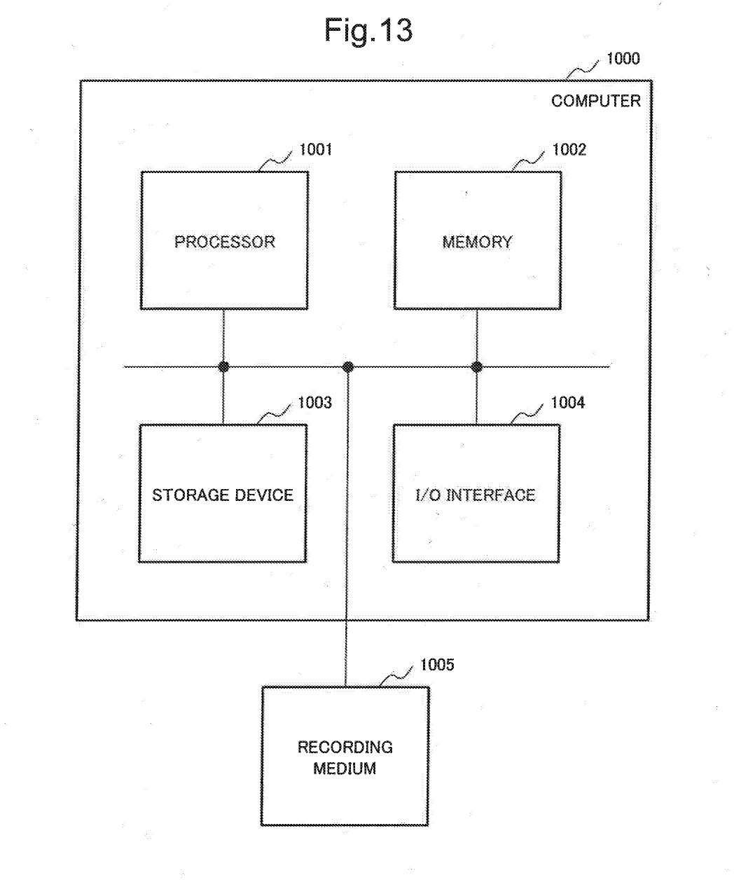

FIG. 13 is a block diagram illustrating a configuration example of a computer 1000 capable of providing the speech processing device according to the respective example embodiments of the present invention.

Referring to FIG. 13, the computer 1000 includes a processor 1001, a memory 1002, a storage device 1003, and an input/output (I/O) interface 1004. Further, the computer 1000 is able to access a recording medium 1005. For example, the memory 1002 and the storage device 1003 include storage devices such as a random access memory (RAM) and a hard disk. For example, the recording medium 1005 includes a storage device such as a RAM and a hard disk, a read only memory (ROM), and a portable recording medium. The storage device 1003 may be the recording medium 1005. The processor 1001 is able to read and write data and a program from and to the memory 1002 and the storage device 1003. For example, the processor 1001 is able to access a terminal device (unillustrated) and an output device (unillustrated) through the I/O interface 1004. The processor 1001 is able to access the recording medium 1005. The recording medium 1005 stores a program causing the computer 1000 to operate as a speech processing device.

The processor 1001 loads a program being stored in the recording medium 1005 and causing the computer 1000 to operate as a speech processing device into the memory 1002. Then, by the processor 1001 executing the program loaded into the memory 1002, the computer 1000 operates as a speech processing device.

For example, each of the units included in a first group described below can be provided by the memory 1002 into which a dedicated program capable of providing a function of each unit is loaded from the recording medium 1005, and the processor 1001 executing the program. The first group includes the standard F0 pattern selecting unit 101, the original-speech F0 pattern selecting unit 103, the original-speech F0 pattern determining unit 105, the F0 pattern concatenating unit 106, the applicable segment searching unit 108, the element waveform selecting unit 201, the original-speech waveform determining unit 203, and the waveform generating unit 204. The first group further includes the F0 pattern generating unit 301 and the waveform parameter generating unit 401.

Further, each of the units included in a second group described below can be provided by the memory 1002 and the storage device 1003 such as a hard disk device, being included in the computer 1000. The second group includes the standard F0 pattern storing unit 102, the original-speech F0 pattern storing unit 104, the original-speech utterance information storing unit 107, the original-speech waveform storing unit 202, the element waveform storing unit 205, the F0 generation model storing unit 302, the waveform generation model storing unit 402, and the waveform feature value storing unit 403.

Furthermore, the units included in the first group and the second group may be provided, in part or in whole, by a dedicated circuit providing a function of each unit.

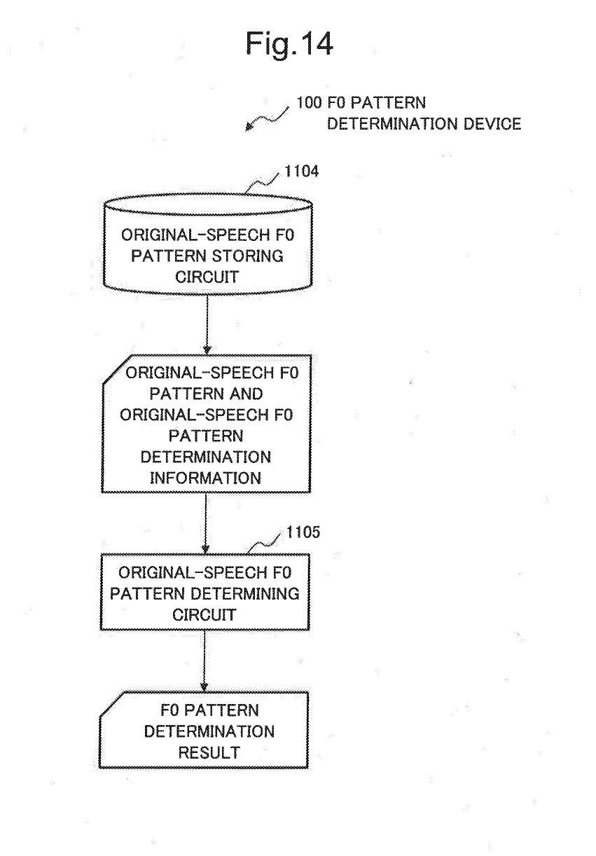

FIG. 14 is a block diagram illustrating a configuration example of the F0 pattern determination device 100 being the speech processing device according to the first example embodiment of the present invention, being implemented with dedicated circuits. In the example illustrated in FIG. 14, the F0 pattern determination device 100 includes an original-speech F0 pattern storing device 1104 and an original-speech F0 pattern determining circuit 1105. The original-speech F0 pattern storing device 1104 may be implemented with a memory.

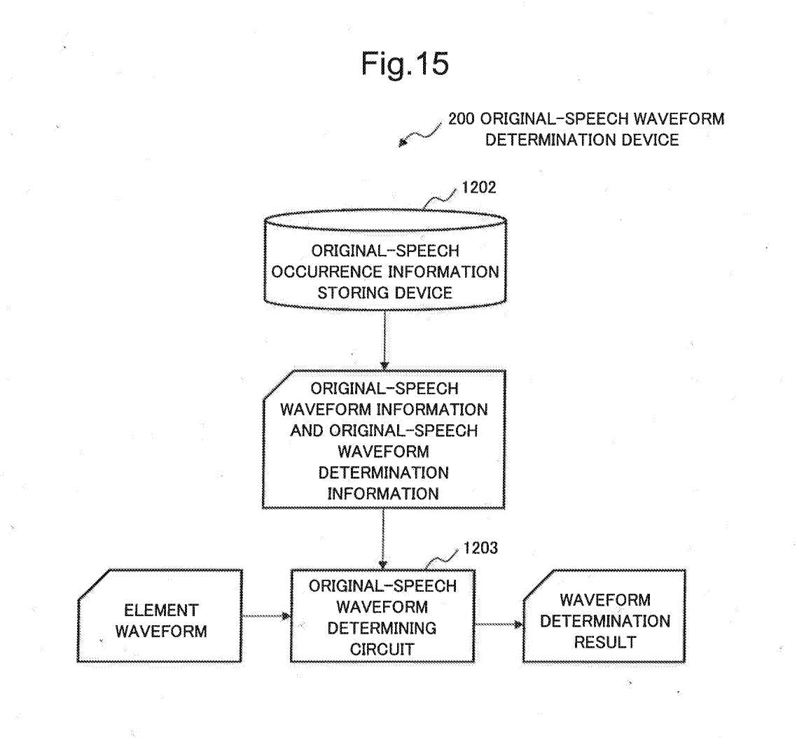

FIG. 15 is a block diagram illustrating a configuration example of the original-speech waveform determination device 200 being the speech processing device according to the second example embodiment of the present invention, being implemented with dedicated circuits. In the example illustrated in FIG. 15, the original-speech waveform determination device 200 includes an original-speech waveform storing device 1202 and an original-speech waveform determining circuit 1203. The original-speech waveform storing device 1202 may be implemented with a memory. The original-speech waveform storing device 1202 may be implemented with a storage device such as a hard disk.

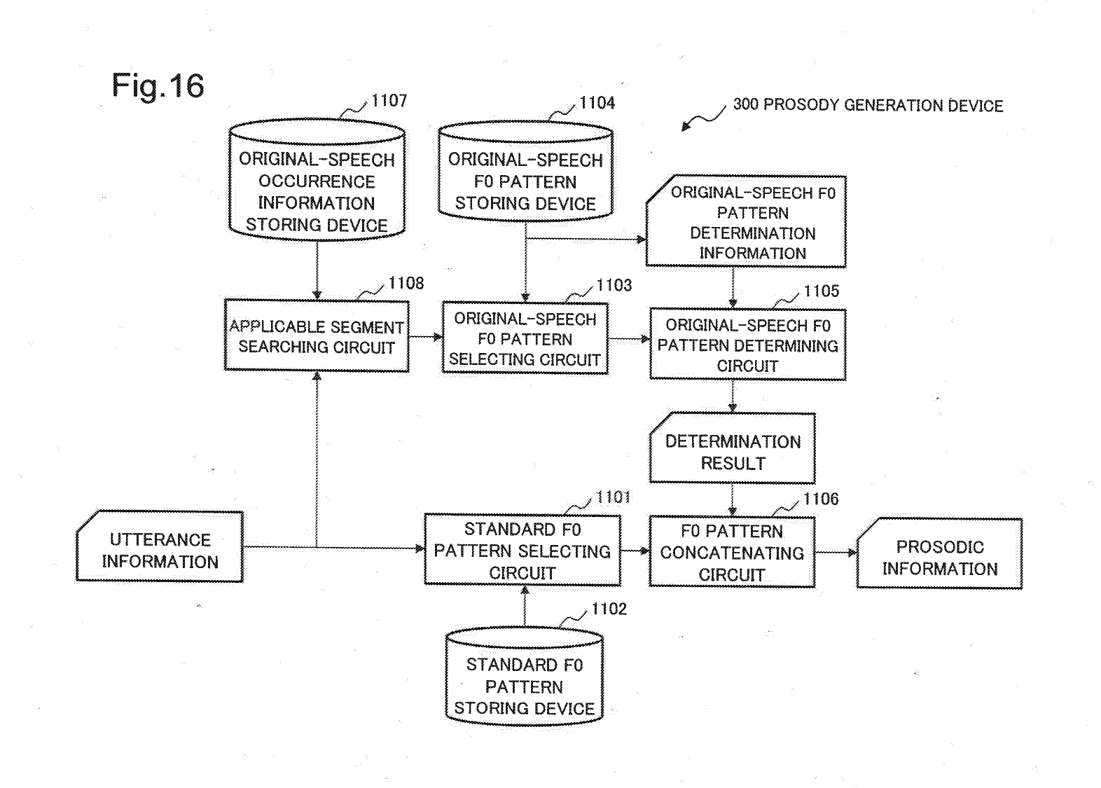

FIG. 16 is a block diagram illustrating a configuration example of the prosody generation device 300 being the speech processing device according to the third example embodiment of the present invention, being implemented with dedicated circuits. In the example illustrated in FIG. 16, the prosody generation device 300 includes a standard F0 pattern selecting circuit 1101, a standard F0 pattern storing device 1102, and an F0 pattern concatenating circuit 1106. The prosody generation device 300 further includes an original-speech F0 pattern selecting circuit 1103, an original-speech F0 pattern storing device 1104, an original-speech F0 pattern determining circuit 1105, an original-speech utterance information storing device 1107, and an applicable segment searching circuit 1108. The original-speech utterance information storing device 1107 may be implemented with a memory. The original-speech utterance information storing device 1107 may be implemented with a storage device such as a hard disk.

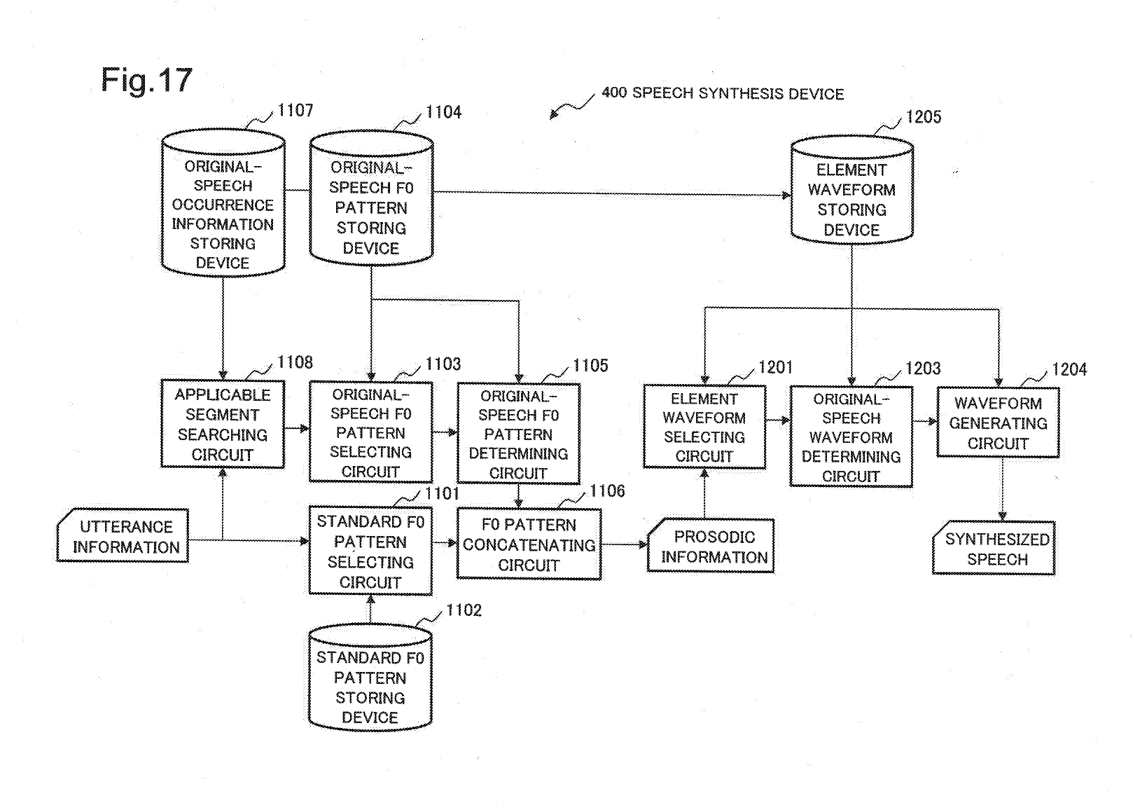

FIG. 17 is a block diagram illustrating a configuration example of the speech synthesis device 400 being the speech processing device according to the fourth example embodiment of the present invention, being implemented with dedicated circuits. In the example illustrated in FIG. 17, the speech synthesis device 400 includes a standard F0 pattern selecting circuit 1101, a standard F0 pattern storing device 1102, and an F0 pattern concatenating circuit 1106. The speech synthesis device 400 further includes an original-speech F0 pattern selecting circuit 1103, an original-speech F0 pattern storing device 1104, an original-speech F0 pattern determining circuit 1105, an original-speech utterance information storing device 1107, and an applicable segment searching circuit 1108. The speech synthesis device 400 further includes an element waveform selecting circuit 1201, an original-speech waveform determining circuit 1203, a waveform generating circuit 1204, and an element waveform storing device 1205. The element waveform storing device 1205 may be implemented with a memory. The element waveform storing device 1205 may be implemented with a storage device such as a hard disk.

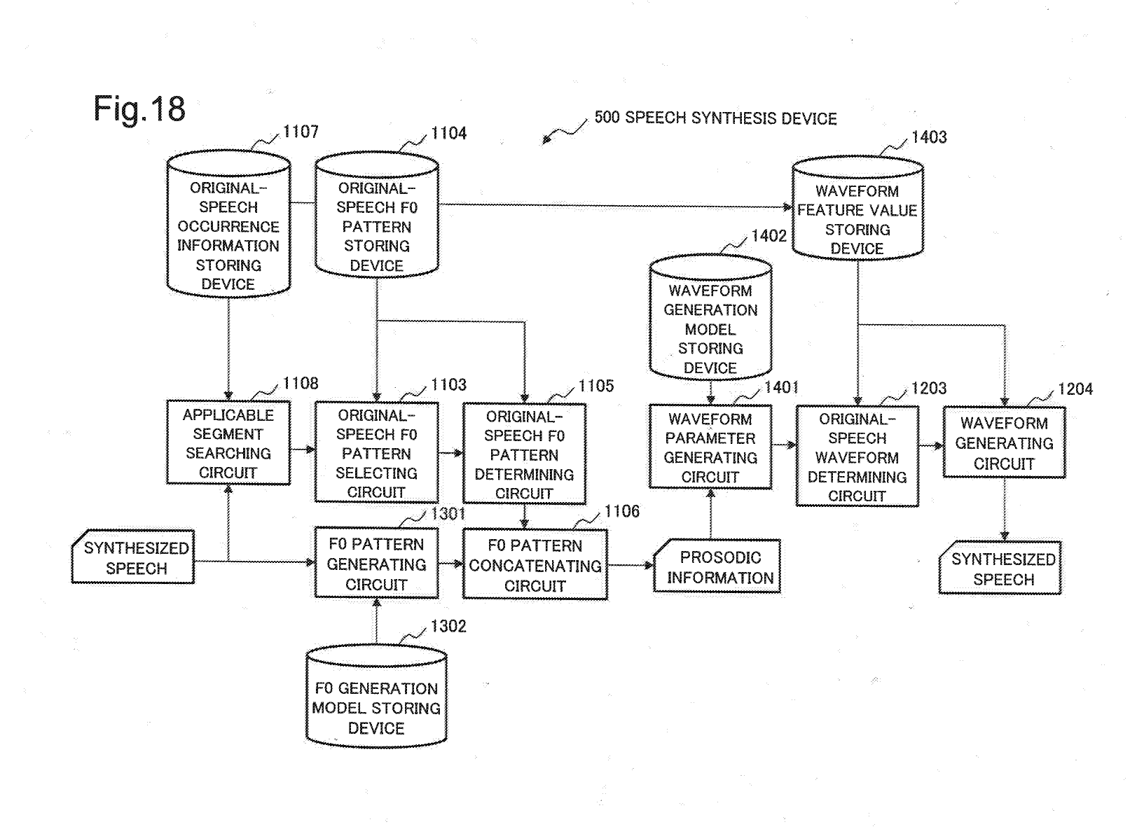

FIG. 18 is a block diagram illustrating a configuration example of the speech synthesis device 500 being the speech processing device according to the fifth example embodiment of the present invention, being implemented with dedicated circuits. In the example illustrated in FIG. 18, the speech synthesis device 500 includes an F0 pattern generating circuit 1301, an F0 generation model storing device 1302, and an F0 pattern concatenating circuit 1106. The speech synthesis device 500 further includes an original-speech F0 pattern selecting circuit 1103, an original-speech F0 pattern storing device 1104, an original-speech F0 pattern determining circuit 1105, an original-speech utterance information storing device 1107, and an applicable segment searching circuit 1108. The speech synthesis device 500 further includes an original-speech waveform determining circuit 1203, a waveform generating circuit 1204, a waveform parameter generating circuit 1401, a waveform generation model storing device 1402, and a waveform feature value storing device 1403. The F0 generation model storing device 1302, the waveform generation model storing device 1402, and the waveform feature value storing device 1403 may be implemented with a memory. The F0 generation model storing device 1302, the waveform generation model storing device 1402, and the waveform feature value storing device 1403 may be implemented with a storage device such as a hard disk.

The standard F0 pattern selecting circuit 1101 operates as the standard F0 pattern selecting unit 101. The standard F0 pattern storing device 1102 operates as the standard F0 pattern storing unit 102. The original-speech F0 pattern selecting circuit 1103 operates as the original-speech F0 pattern selecting unit 103. The original-speech F0 pattern storing device 1104 operates as the original-speech F0 pattern storing unit 104. The original-speech F0 pattern determining circuit 1105 operates as the original-speech F0 pattern determining unit 105. The F0 pattern concatenating circuit 1106 operates as the F0 pattern concatenating unit 106. The original-speech utterance information storing device 1107 operates as the original-speech utterance information storing unit 107. The applicable segment searching circuit 1108 operates as the applicable segment searching unit 108. The element waveform selecting circuit 1201 operates as the element waveform selecting unit 201. The original-speech waveform storing device 1202 operates as the original-speech waveform storing unit 202. The original-speech waveform determining circuit 1203 operates as the original-speech waveform determining unit 203. The waveform generating circuit 1204 operates as the waveform generating unit 204. The element waveform storing device 1205 operates as the element waveform storing unit 205. The F0 pattern generating circuit 1301 operates as the F0 pattern generating unit 301. The F0 generation model storing device 1302 operates as the F0 generation model storing unit 302. The waveform parameter generating circuit 1401 operates as the waveform parameter generating unit 401. The waveform generation model storing device 1402 operates as the waveform generation model storing unit 402. The waveform feature value storing device 1403 operates as the waveform feature value storing unit 403.

While the present invention has been described above with reference to the example embodiments, the present invention is not limited to the aforementioned example embodiments. Various changes and modifications that can be understood by a person skilled in the art may be made to the configurations and details of the present invention, such as an approximate curve derivation method, a prosodic information generation scheme, and a speech synthesis scheme, within the scope of the present invention.

This application claims priority based on Japanese Patent Application No. 2014-260168 filed on Dec. 24, 2014, the disclosure of which is hereby incorporated by reference thereto in its entirety.

### REFERENCE SIGNS LIST

100 F0 pattern determination device

101 Standard F0 pattern selecting unit

102 Standard F0 pattern storing unit

103 Original-speech F0 pattern selecting unit

104 Original-speech F0 pattern storing unit

105 Original-speech F0 pattern determining unit

106 F0 pattern concatenating unit

107 Original-speech utterance information storing unit

108 Applicable segment searching unit

200 Original-speech waveform determination device

201 Element waveform selecting unit

202 Original-speech waveform storing unit

203 Original-speech waveform determining unit

204 Waveform generating unit

205 Element waveform storing unit

300 Prosody generation device

301 F0 pattern generating unit

302 F0 generation model storing unit

400 Speech synthesis device

401 Waveform parameter generating unit

402 Waveform generation model storing unit

403 Waveform feature value storing unit

500 Speech synthesis device

1000 Computer

1001 Processor

1002 Memory

1003 Storage device

1004 I/O interface

1005 Recording medium

1101 Standard F0 pattern selecting circuit

1102 Standard F0 pattern storing device

1103 Original-speech F0 pattern selecting circuit

1104 Original-speech F0 pattern storing device

1105 Original-speech F0 pattern determining circuit

1106 F0 pattern concatenating circuit

1107 Original-speech utterance information storing device

1108 Applicable segment searching circuit

1201 Element waveform selecting circuit

1202 Original-speech waveform storing device

1203 Original-speech waveform determining circuit

1204 Waveform generating circuit

1205 Element waveform storing device

1301 F0 pattern generating circuit

1302 F0 generation model storing device

1401 Waveform parameter generating circuit

1402 Waveform generation model storing device

1403 Waveform feature value storing device

What is claimed is:

1. A speech processing device comprising:
a memory and a processor executing a program loaded on the memory, wherein:
the memory stores an original-speech F0 pattern being an fundamental frequency(F0) pattern extracted from recorded speech, and first determination information associated with the original-speechF0 pattern; and
the processor is configured to function as a first determining unit for determining whether or not to reproduce the original-speech, in accordance with the first determination information.

2. The speech processing device according to claim 1, wherein:
the memory stores original-speech utterance information representing an utterance content of the recorded speech, and the original-speech F0 pattern in a mutually associated manner;
the processor is further configured to function as:
searching unit for searching for a segment in which the original-speech is reproduced, in accordance with the original-speech utterance information and utterance information representing an utterance content of synthesized speech; and
first selecting unit for selecting the original-speech F0 pattern related to the segment from the stored original-speech F0 pattern, wherein
the first determining unit determines whether or not to reproduce the selected original-speech, in accordance with the first determination information.

3. The speech processing device according to claim 1, wherein
the memory stores, as the first determination information, at least one of two-valued flag information, a scalar value, and a vector value, and
the first determining unit determines whether or not to reproduce the original-speech, by using at least one of the flag information, the scalar value, and the vector value, stored in the memory.

4. The speech processing device according to claim 1, wherein:
the memory stores original-speech utterance information being associated with the original-speech F0 pattern and representing an utterance content of recorded speech, a standard F0 pattern approximately representing a form of the F0 pattern in a specific segment, and attribute information of the standard F0 pattern;
the processor is further configured to function as:
searching unit for searching for a segment in which the original-speech is reproduced, in accordance with the original-speech utterance information and utterance information representing an utterance content of synthesized speech;
first selecting unit for selecting the original-speech F0 pattern related to the segment from the stored original-speech F0 pattern;
second selecting unit for selecting the standard F0 pattern in accordance with input utterance information and the attribute information; and
concatenating unit for generating the F0 pattern by concatenating the selected standard F0 pattern with the original-speech F0 pattern.

5. The speech processing device according to claim 1, the processor is further configured to function as:
third selecting unit for selecting an element waveform in accordance with utterance information representing an utterance content of synthesized speech, and the reproduced original-speech; and
waveform generating unit for generating synthesized speech in accordance with the selected element waveform.

6. The speech processing device according to claim 5, wherein:
the memory stores original-speech utterance information being associated with the original-speech F0 pattern and representing an utterance content of the recorded speech;
the processor is further configured to function as:
searching unit for searching for a segment in which the original-speech is reproduced, in accordance with the original-speech utterance information and the utterance information; and
first selecting unit for selecting the original-speech F0 pattern related to the segment from the stored original-speech F0 pattern, wherein
the first determining unit determines whether or not to reproduce the selected original-speech, in accordance with the first determination information.

7. The speech processing device according to claim 5, wherein:
the memory stores a standard F0 pattern approximately representing a form of the F0 pattern in a specific segment, and attribute information of the standard F0 pattern;
the processor is further configured to function as:
second selecting unit for selecting the standard F0 pattern in accordance with input utterance information and the attribute information; and
concatenating unit for generating the F0 pattern by concatenating the selected standard F0 pattern with the original-speech F0 pattern, wherein
the third selecting unit selects the element waveform by using the generated F0 pattern.

8. The speech processing device according to claim 7, wherein:
the memory stores a plurality of element waveforms of the recorded speech and second determination information associated with the plurality of element waveforms; and
the processor is further configured to function as:
second determining unit for determining whether or not to reproduce a waveform of the recorded speech by using the selected element waveform, in accordance with the second determination information, wherein
the waveform generating unit generates the synthesized speech in accordance with the reproduced waveform of the recorded speech.

9. A speech processing method comprising:
storing an original-speech F0 pattern being an F0 pattern extracted from recorded speech, and first determination information associated with the original-speech F0 pattern; and
determining whether or not to reproduce the original-speech, in accordance with the first determination information.

10. A recording medium storing a program causing a computer to perform:
processing of storing an original-speech F0 pattern being an F0 pattern extracted from recorded speech, and first determination information associated with the original-speech F0 pattern; and
processing of determining whether or not to reproduce the original-speech, in accordance with the first determination information.
